(19) United States
(12) Patent Application Publication
(10) Pub. No.: US 2019/0236527 A1
(43) Pub. Date: Aug. 1, 2019

(54) Smart Container Inventory Management System

(71) Applicant: Walmart Apollo, LLC, Bentonville, AR (US)

(72) Inventors: Arnabh Bhaumik, Bentonville, AR (US); Behzad Nemati, Springdale, AR (US); John Jeremiah O'Brien, V, Farmington, AR (US)

(21) Appl. No.: 16/231,397

(22) Filed: Dec. 22, 2018

Related U.S. Application Data
(60) Provisional application No. 62/624,192, filed on Jan. 31, 2018.

(51) Int. Cl. G06Q 10/08; B65G 1/137

(52) U.S. Cl. CPC G06Q 10/087; B65G 1/1378; B65G 1/1371

(57) ABSTRACT

Examples of the disclosure provide systems and methods for inventory management using smart containers. A computing system obtains, by a smart container component implemented on the computing system, sensor data from a set of sensors associated with a smart container. The computing system identifies an inventory status for the smart container using the obtained sensor data and determines whether to initiate inventory actions for the smart container based on the identified inventory status and a set of rules associated with the smart container.

### BACKGROUND

Items in a store environment are typically assigned to one or more areas, including display areas on a shelf, counter, refrigerated unit, freezer unit, end-cap, display cabinet, or other location, and inventory areas, such as top-shelf areas, backrooms, inventory storage areas, and the like. A given item may be distributed throughout these areas and found in more than one location of a store. Likewise, in a consumer environment, a consumer may store items throughout various locations of their home or business, and may have a particular item located at various location throughout their home or business.

### SUMMARY

Examples of the disclosure provide a computer-implemented method for inventory management using smart containers. The computer-implemented method includes obtaining, by a smart container component implemented on a processor, sensor data from a set of sensors associated with a smart container. An inventory status is identified for the smart container using the obtained sensor data. A determination is made regarding whether to initiate a local inventory query for the smart container based on the identified inventory status and set of rules associated with the smart container.

In another aspect, a computing system is provided for smart container inventory management. The computing system includes a memory device storing computer-executable instructions, a processor configured to execute the computer-executable instructions, and a smart container component implemented on the memory and executed by the processor to obtain sensor data from a set of sensors configured to monitor a container. The smart container component identifies an inventory status for the monitored container associated with the set of sensors based on the obtained sensor data. The smart container component determines whether to initiate a local inventory query for the monitored container based on the identified inventor status.

In yet another aspect, a smart container device is provided. The smart container device includes a housing, a processing unit implemented within the housing, a memory communicatively coupled to the processing unit, a sensor array implemented within the housing and configured to monitor a container associated with the smart container device, and a smart container component implemented on the memory and executed by the processor to monitor sensor data generated by the sensor array to manage an inventory status for the monitored container.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example inventory management environment using smart containers.

FIG. 2 is a block diagram illustrating an example smart container network environment for inventory management.

FIG. 3 is a block diagram illustrating an example smart container environment.

FIG. 4 is a block diagram illustrating an example inventory management environment that may be used with a computing device, such as the computing device shown in FIG. 1.

FIG. 5 is a block diagram illustrating an example inventory management environment operating as a cloud-based service using blockchain technology.

FIG. 6 is a block diagram illustrating an example inventory management environment operating as a cloud-based service using a distributed network.

FIG. 7 is a flowchart illustrating an example method for inventory management using smart containers.

FIG. 8 is a flowchart illustrating an example method for managing inventory with smart containers using a computing device, such as the computing device shown in FIG. 1.

FIGS. 9 and 10 are sequence diagrams illustrating example methods for managing inventory with smart containers using a distributed network, such as the distributed network shown in FIG. 6.

FIG. 11 is a block diagram illustrating an example operating environment for a computing device, such as the computing device shown in FIG. 1.

Corresponding reference characters indicate corresponding parts throughout the drawings.

### DETAILED DESCRIPTION

Referring to the figures, examples of the disclosure enable one or more smart containers to control or manage inventory. A master node, or smart container device, may manage local inventory within a network. The smart container device may monitor inventory status for a plurality of inventory items, make and execute inventory decisions, and facilitate communication between other smart containers on the network. The smart container may aggregate communication of the local network into a consolidated communication for a distributed network, in some examples. Blockchain technology, for example, may be used to facilitate the control and/or management of inventory by the smart container device. A blockchain may be used as a public ledger, including an ordered and timestamped record of transactions. The examples described herein enable one or more transactions associated with smart containers to be administered or managed in accordance with a reference configuration of the smart container.

Aspects of the disclosure provide for a computing device that performs one or more operations in an environment including a plurality of devices coupled to each other via a network (e.g., a local area network (LAN), a wide area network (WAN), the Internet). For example, a computing device may communicate with one or more other computing devices, including one or more smart container devices and/or user devices, to facilitate inventory management. In some embodiments, the computing device analyzes data associated with a smart container device to facilitate and validate a transaction between the smart container device and a user, such as a supplier or distributer for example.

The systems and processes described herein may be implemented using computer programming or engineering techniques including computer software, firmware, hardware or a combination or subset thereof. Aspects of the disclosure improve processor security, data integrity, data storage security, data security in networked devices, data transmission security, and/or communication between computing systems by controlling communications and managing access to various accounts using a public key cryptographic system and/or by verifying and validating transaction data using a proof-of-work protocol and a consensus protocol. Additionally, some aspects may improve user experience, user efficiency, and/or user interaction performance by facilitating transactions in an effective and efficient manner. Moreover, some aspects may increase processor speed, improve operating system resource allocation, and/or reducing error rate by automating the processing of large volumes of data.

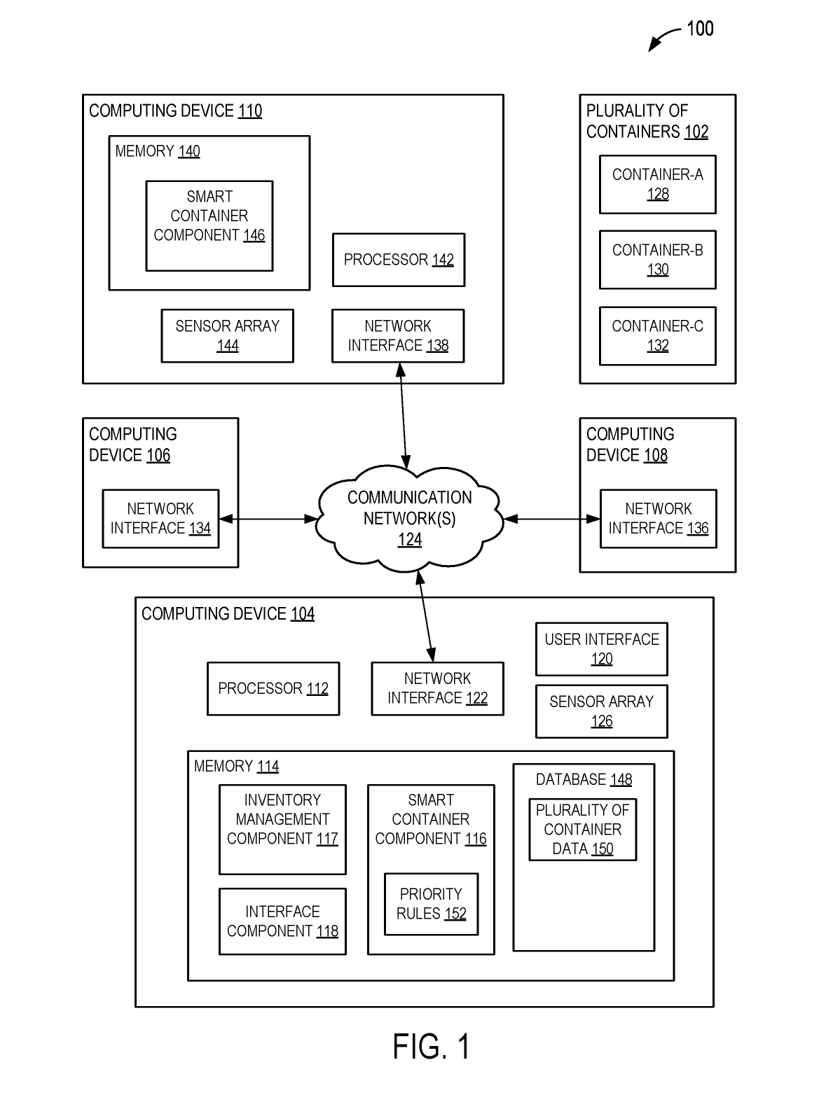

FIG. 1 is a block diagram illustrating an example inventory management environment 100 for managing one or more smart containers or smart container devices. The environment 100 includes a plurality of “things,” such as a plurality of containers 102, computing device 104, computing device 106, computing device 108, and computing device 110. In one example, the environment 100 may be an Internet of Things (IoT) ecosystem. Computing devices 104, 106, 108, and 110 are configured to perform one or more operations to accomplish one or more particular tasks. As used herein, a computing device includes one or more computing systems that execute instructions (e.g., as application programs, operating system functionality, or both) to implement one or more operations as described herein. In some examples, a computing device includes a group of processing units or other computing systems. A computing device may include, for example, a desktop computer, a server computer, a kiosk, a set top box, and/or a tabletop device. Additionally, or alternatively, a computing device may include more-portable computing devices, such as a mobile device, a laptop computer, a tablet device, a netbook, a gaming device, a wearable device, and/or a portable media player.

In some examples, the computing device 104 has at least one processor 112 and memory 114, which may be in the form of computer-readable media. The processor 112 includes any quantity of processing units, and is programmed to execute computer-executable instructions for implementing aspects of the disclosure. The instructions may be performed, for example, by one or more processors within the computing device 104 (as shown in FIG. 1). Additionally, or alternatively, the instructions may be performed by at least one processor external to the computing device 104. The processor 112 may represent an implementation of analog techniques to perform the operations described herein. For example, the operations may be performed by an analog computing device and/or a digital computing device.

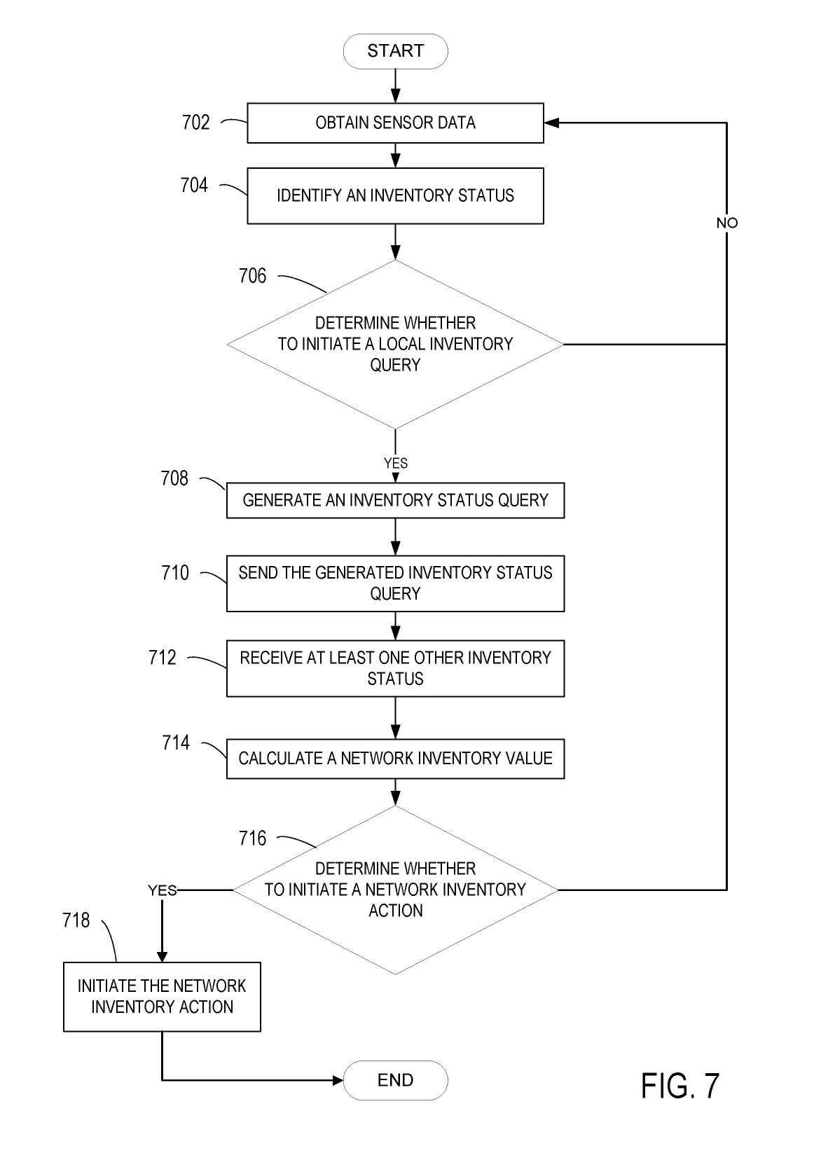

In some examples, the processor 112 is programmed to execute instructions, such as those illustrated in the figures (e.g., FIGS. 7, 8, 9, 10). The instructions may be stored and/or maintained at the memory 114. The memory 114 includes any quantity of media associated with or accessible by the computing device 104. Memory 114 may be internal to the computing device 104 (as shown in FIG. 1), external to the computing device 104, or both. For example, computer-readable media may include data stored locally at the computing device 104, data access points stored locally at the computing device 104 and associated with data stored remote from the computing device 104, or any combination of local and remote data. In some examples, the computer-readable media includes read-only memory and/or memory wired into an analog computing device.

Memory 114 stores and/or maintains, among other data, one or more applications. The applications, when executed by the processor 112, operate to perform one or more operations and/or provide functionality on the computing device 104. Example applications include smart container component 116 and inventory management component 117, which may represent applications for facilitating smart container inventory management. The smart container component 116 may provide one or more computer-executable components for managing a smart container device, such as computing device 104. The inventory management component 117 may provide one or more computer-executable components for managing inventory of a container associated with the smart container device.

In some examples, the computing device 104 includes an interface component 118 stored and/or maintained at the memory 114. When executed by the processor 112, the interface component 118 may cause the computing device 104 to perform one or more operations and/or provide functionality that facilitate smart container communication. The interface component 118 may include computer-executable instructions (e.g., a driver) for operating one or more user interfaces 120 and/or network interfaces 122.

A user interface 120, for example, may be used to present information to and/or receive user input from a user of the computing device 104. User interface 120 may include any output and/or input device that enables information to be presented to and/or received from the user, such as a display device, a monitor, a touchscreen panel, a graphics card, a speaker, a sound card, a printer, a vibration motor, a natural user interface, a tablet, a microphone, a keyboard, a pointing device, a sensor device, a digital camera, an accelerometer, and the like. The user interface 120 may be internal to the computing device 104 (as shown in FIG. 1), external to the computing device 104, or both. In other examples, user interface 120 may be an optional component.

A network interface 122 may be used to transmit data to and/or receive data from one or more other computing systems (e.g., computing device 106, computing device 108, computing device 110, etc.). Network interface 122 may include any output and/or input device that enables information to be presented to and/or received from another computing system, such as a modem, a network interface controller (NIC), a WI-FI® brand local area wireless computing network-enabled device, a BLUETOOTH® brand wireless technology-enabled device, a ZIGBEE® brand wireless technology-enabled device, Z-WAVE™ brand wireless technology-enabled device, and/or an NFC wireless communication-enabled device. The network interface 122 may be internal to the computing device 104 (as shown in FIG. 1), external to the computing device 104, or both.

In some examples, one or more applications, such as the smart container component 116 and/or inventory management component 117, communicate with counterpart applications or services such as web services accessible via one or more communication network(s) 124 that enable data to be transferred between a plurality of computing systems coupled to the communication network(s) 124. For example, the applications may represent server-side applications that enable client-side services to be provided at one or more client devices (e.g., computing device 104).

Computing device 104 may also include sensor array 126. Sensor array 126 may be a set of one or more sensors configured to monitor a container. The one or more sensors may include, without limitation, optical sensors, image capture devices, hyperspectral imaging sensors, weight sensors, thermometers, barometers, hygrometers, lasers, lidar, ultrasonic sensors, infrared sensors, photoionization detectors, gas sensors, electrochemical gas sensors, scanner devices, or any other suitable sensor, for example. As used herein, a container may be any area, enclosure, surface, or space capable of including physical items. For example, a container may include, without limitation, a shelf, a display, a case, a unit, a structure, a cabinet, a room, an enclosure, a surface, a counter, a stand, or any other suitable means of storing items. Sensor array 126 may be configured to monitor an associated container for inventory status of an associated inventory item, for example.

Smart container component 116 may associate or otherwise assign a container, such as container-A 128, to computing device 104. In this example, sensor array 126 may be configured to monitor container-A 128 for inventory status of an associated inventory item during a period in which computing device 104 is assigned to container-A 128. In some examples, computing device 104 may be configured for a particular container, such as container-A 128. In other examples, computing device 104 may be portable and reconfigurable, such that computing device 104 may be attached to and/or associated with, and removed from various containers. In an example where computing device 104 is relocated to another container, smart container component 116 may reassign computing device 104 to the newly associated container, for example. In this example, sensor array 126 may be reconfigured based on the newly associated container. In other examples, computing device 104 may be implemented within a container, such as container-A 128, wherein container-A 128 is a smart container with a dedicated device.

Environment 100 may have any number of containers, such as plurality of containers 102. In this illustrative example, container-B 130 and container-C 132 may be other containers that a computing device may be assigned and/or associated with in order to monitor the inventor status of items associated with the respective containers. Computing device 106 having network interface 134, computing device 108 having network interface 136, and computing device 110 having network interface 138 are illustrative examples of other smart container devices within environment 100. Computing device 106, computing device 108, and computing device 110 may be assigned to other containers, and may communicate via communication network(s) 124 to perform inventory management operations within environment 100. Computing device 106, computing device 108, and computing device 110 may be illustrative examples of computing devices such as computing device 104. In one example, each computing device in environment 100 operates as a node within the network of environment 100. A master node may operate to facilitate communication and management between child nodes on the network, in some examples. The master node may be any node in the network, and may change based on addition/removal of nodes to the network, operability of nodes on the network, and the like.

In some examples, inventory management component 117 may be activated on the master node and deactivated on the child nodes, such that the master node aggregates communication from the other nodes on the network and transmits a consolidated communication on behalf of the network, as shown in FIG. 1 for illustrative purposes. In this example, computing device 110 may communicate inventory data to computing device 104, and inventory management component 117 may generate an inventory action on behalf of the network.

Computing device 110 as shown includes memory 140, processor 142, and sensory array 144. Memory 140 may be an illustrative example of memory such as that described above for memory 114. Processor 142 may be any number of processing units, such as that described above for processor 112. Sensor array 144 may be a set of one or more sensors configured to monitor a container, such as that described above for sensory array 126. Sensor array 144 may be configured to monitor a different container than the monitored container of sensor array 126, for inventory status of an associated inventory item, for example. In some examples, the inventory items associated with multiple monitored containers may include some of the same items. In other words, container-A may include the same inventory item as that of container-B.

For example, smart container component 116 may be implemented on a smart container device (e.g. computing device 104) assigned to container-A 128, and smart container component 146 may be implemented on another smart container device (e.g. computing device 108) assigned to container-B 130. Smart container component 116 may identify an inventory status of container-A 128 that triggers an inventory status query to smart container component 146. Smart container component 146 may return an inventory status response corresponding to the inventory status of container-B 130. Smart container component 116 uses the inventory status response from smart container component 146 along with the identified inventory status of container-A 128 to calculate a network inventory status and to determine whether to initiate a network inventory action.

An inventory status, as used herein, may be any indication of the status of an item associated with a given container, such as, without limitation, an item count, an item quantity, an item level, an item freshness level, an item expiration status, and/or any other suitable indication, for example. The different status types (e.g. item count, item level, item quantity, etc.) may be pre-defined and/or configurable based on the item type. For example, an item that is identifiable in discrete instances may be configured for an item count status identifier, whereas an item that is non-solid, such as a liquid, may be configured for an item level status identifier. An item level may be relative to a threshold value and/or a pre-configured or dynamically identified amount, such as, without limitation, full, empty, half-full, or any specific range or value therein.

For example, a container may be associated with a paper product, such as paper towels. The inventory status for the container may be expressed by an item count, such as by individual rolls, individual packages of multiple rolls, or individual cases of multiple packages, for example. The inventory status may be a value with an associated identifier of the count type, such as 2-rolls, or 2-packages, for example. The inventory status identifier type may be pre-defined parameter based on the associated inventory item type, or may be a configurable parameter, in some examples.

A network inventory status refers to an aggregated inventory status for a specific inventory item type. For example, an item that is distributed across multiple monitored containers within environment 100 may be managed using smart containers to monitor the individual container inventory as well as the aggregated network inventory of the inventory item. In this way, aspects of the disclosure described herein enable smart monitoring of items physically distributed throughout various locations of an environment to accurately and efficiently manage inventory.

Computing device 104 may include database 148 in some examples. In other examples, database 148 may be implemented remote from computing device 104 and accessible via communication network(s) 124. Database 148 is a network database that includes plurality of container data 150 for the plurality of containers 102 within the network environment 100. Plurality of container data 150 may include an identifier for each individual container in the plurality of containers 102, and associated container data for the container, such as associated inventory item data, and/or associated inventory item rules and/or parameters, and the like. Plurality of container data 150 may be dynamically updated as computing devices are assigned and/or reassigned to containers within the network. In some examples, smart container component 116 uses plurality of container data 150 to identify one or more other network containers that are associated with a same item as that of the container assigned to smart container component 116, in order to send inventory status queries for the given inventory item to the computing devices corresponding to the containers associated with that inventory item. In other examples, smart container component 116 may ping individual computing devices on the network with the inventory item status query including an item identifier, such that computing devices that recognize the item identifier as associated with their monitored container respond to the query and computing devices that do not recognize the item identifier to not respond.

Smart container component may also include priority rules 152. Priority rules 152 include a container prioritization scheme, a communication scheme, and other inventory management schemes. A container prioritization scheme may provide a map, table, or schema for prioritizing inventory adjustment per container. For example, in a store environment in which inventory is located on each of a modular shelf, an end-cap display, a feature display, a top-stock area, and a backroom inventory area, the container prioritization scheme may assign a priority to each associated container, which may be used to generate inventory relocation instructions according to the prioritization scheme. In this illustrative example, a feature display may have a top priority, followed by the end-cap display, the modular shelf, the top-stock area, and finally the backroom. A smart container component assigned to the feature display may identify an inventory status that triggers an inventory relocation instruction based on the priority scheme to move available inventory from one of the other containers to the feature display, for example. In another example, a network inventory status identified may indicate that overall inventory is low across all containers, such that an order replenishment threshold is reached, and a network inventory action is initiated to place a replenishment order for the inventory item.

In some examples, containers may be located within an interior portion of a structure or building, adjacent to an exterior portion of a structure or building, or in any other suitable environment. As described above, containers may include any manner of area associated with items. In a store environment, these areas may include backrooms, storage rooms, modular, floor displays, feature displays, display racks, shelving, stand-alone units, topstock areas, refrigerated units, cold-storage units, fresh-storage units, warming units, and/or any other suitable area. A topstock area, or shelf, may be an uppermost shelf or top shelf on a display floor, for example. In other examples, containers may be associated with a personal environment, such as a home or residential environment, and containers may include areas such as cabinets, shelving, closets, garage storage, storage sheds, basements, pantries, refrigerator units, freezer units, attic storage, and/or any other suitable area for storing inventory items.

The communication scheme of priority rules 152 may include a prioritization of smart container communication and network inventory action communication. For example, the communication scheme may be configured to prioritize local communication over distributed communication, such that the local network of smart containers communicates to establish a network inventory status and determine whether or not to initiate a distributed network communication on behalf of the local network. In other words, a local first prioritization. This enables the smart container components executing within the network to prioritize inventory management within the network before moving to the distributed network for inventory management.

Inventory actions may include, without limitation, relocating inventory from one or more container(s) to one or more other container(s), generating an inventory relocation instruction, restocking an inventory item from one container to one or more other containers, generating a replenishment order for an inventory item, generating an inventory alert or notification corresponding to the inventor item and/or a specific container or set of containers, generating an order request for user verification, generating a validation prompt for an inventory action, and the like.

In one example, a determined network inventory value may correspond to a rule that triggers initiation of a specific inventory action. A feature display that has an inventory status below a threshold value may automatically trigger a restock from another container, such as a topstock or backroom container for example. As another example, the prioritization scheme may indicate that a restock to a feature display should occur first from a topstock container, then alley modular shelf container, before a backroom container.

In another illustrative example of a home environment, a determined local inventory value may correspond to a rule that triggers an inventory notification to be sent to a user device. A monitored container at a pantry location may reach a threshold value for an inventory item, such as paper towels, that triggers a local network query and returns an identification of additional paper towel units in a garage storage container. The determined network inventory status may be calculated, and a rule may trigger the notification to alert a user to transfer the item from the garage storage location to the pantry storage location, for example. As another example, the determined network inventory status may reach a threshold that triggers a notification to a user of an auto-generated replenishment order for user verification.

As yet another example, the inventory management environment may be integrated with an order fulfillment system, such that the inventory management environment may reconcile outstanding purchase orders and/or invoices with determined network inventory status to determine whether or not to initiate a network inventory action, such as generating an inventory order for an item. In this example, if a determined network inventory status indicates or otherwise triggers a rule that inventory replenishment is needed, and the system identifies an outstanding purchase order with an anticipated delivery date within a threshold range that satisfies the inventory status criteria, the system may determine that a network inventory action is not needed at the current time. In other examples, if the outstanding purchase order is for a future fulfillment date outside a required time period or threshold range, the system may determine that a network inventory action is required to order additional inventory out-of-band.

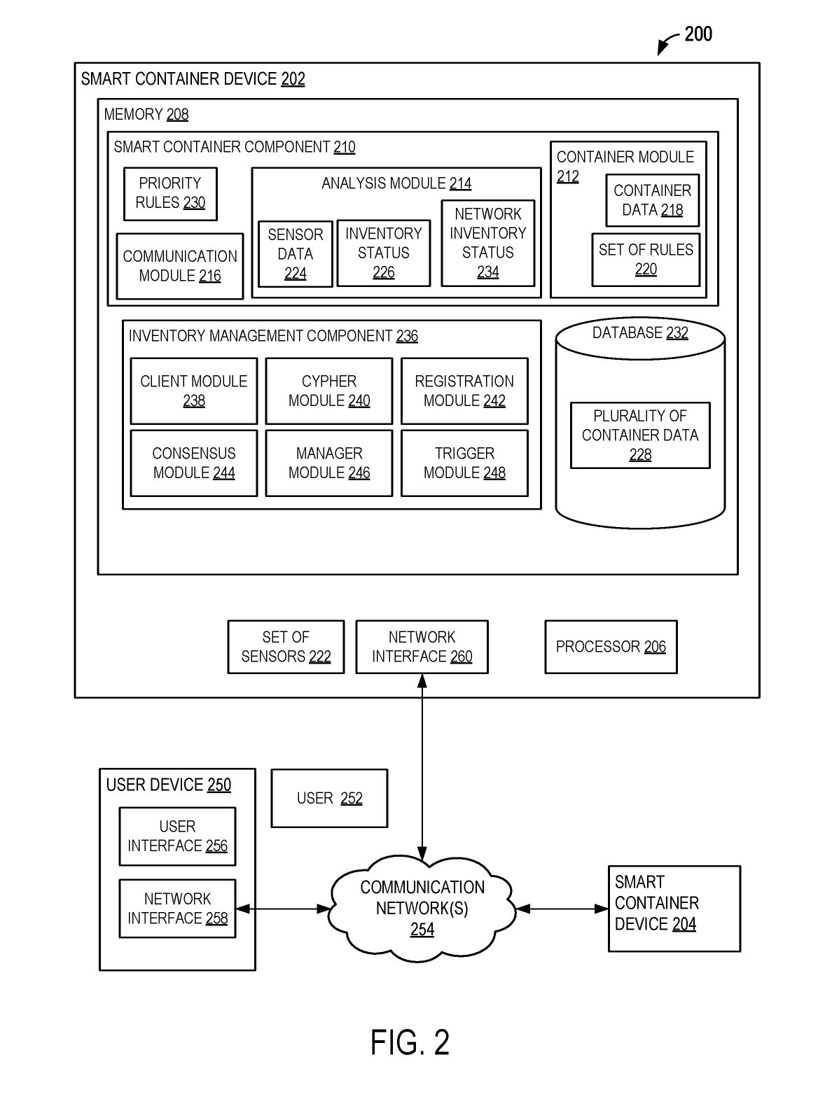

FIG. 2 is a block diagram illustrating an example inventory management environment 200 for smart containers. Environment 200 may include any number of smart container devices, such as smart container device 202 and smart container device 204. Smart container device 202 may be an illustrative example of one implementation of computing device 104 in FIG. 1. Smart container device 204 may be an illustrative example of one implementation of computing device 110 in FIG. 1.

Smart container device 202 includes processor 206 and memory 208. Processor 206 may be an illustrative example of one implementation of processor 112 in FIG. 1. Memory 208 may be an illustrative example of one implementation of memory 114 in FIG. 1. Memory 208 includes smart container component 210 which may be an illustrative example of one implementation of smart container component 116 in FIG. 1.

Smart container component 210 includes container module 212, analysis module 214 and communication module 216. Container module 212 manages the association and/or assignment of smart container device 202 to a given container. Container module 212 obtains and stores container data 218 for the assigned container and obtains and/or generates set of rules 220 for the assigned container and the associated inventory item(s). Container data 218 may include a container identifier, identification of associated inventory item or items, and container parameters for the assigned container. In some examples, container data 218 may be cached for the duration of an association, such as when smart container device 202 is assigned to the given container, and upon container device 202 being reassigned to a different container, container data 218 may be flushed and/or updated with the container data of the newly assigned container. In some examples, sensor data obtained by/from set of sensors 222 may be used by container module 212 to identify a container assignment, such as container location, associated inventory item(s), and the like, in order to generate container data 218.

As described herein, a container may be associated with one or more inventory item types. In some examples, a container may be associated with one inventory item type. In other examples, a container may be associated with two or more inventory item types. Container parameters may include container location (e.g. relative to a planogram and/or modular, relative to a structure, etc.), physical or spatial dimensions of the container, container capacity data (e.g. weight tolerances, etc.), container configuration data (e.g. shelving, display, case, cabinet, etc.), container type data (e.g. dry storage, refrigerated storage, freezer storage, cold-chain compliance-related data, etc.), and/or spatial ranges for lanes or sub-spaces of the container associated with individual item types (i.e. a shelf having multiple lanes for various items, each lane associated with an individual item).

Set of rules 220 may include pre-defined rules corresponding to the inventory item associated with the container, such as local, federal, regulatory, industry, store-specific, and/or user-specific rules. Set of rules 220 may also include pre-defined rules corresponding to the identified container type and container configuration, such as cold-chain compliance rules for example. Set of rules 220 may further include network inventory rules that are pre-defined or configured for environment 200, such as item-specific network inventory threshold parameters, and the like.

Smart container device 202 includes set of sensors 222. Set of sensors 222 may be one or more sensors, such as those described with respect to sensor array 126 in FIG. 1. Set of sensors 222 may be configured by container module 212 to monitor an associated container based on container data 218 and set of rules 220. Analysis module 214 obtains sensor data 224 from set of sensors 222 and uses the obtained sensor data 224, container data 218, and set of rules 220 to identify an inventory status 226 of the monitored container and determine if a local inventory query should be initiated.

Analysis module 214 may determine whether to initiate a local inventory query based on the identified inventory status 226 and the set of rules 220 corresponding to the monitored container. In some examples, a local inventory query is determined based on a threshold level of inventory for the monitored container. If analysis module 214 decides to initiate an inventory status query, analysis module 214 may generate the query for transmission by communication module 216.

Communication module 216 may obtain plurality of container data 228 from database 232. Database 232 may be implemented within memory 208, as shown in FIG. 2, implemented remote from smart container device 202 (not shown), and/or a combination of both. Plurality of container data 228 may be an illustrative example of one implementation of plurality of container data 150 in FIG. 1. Communication module 216 may use plurality of container data 228 and priority rules 230 to identify one or more other smart container devices to query for local inventory status. Priority rules 230 may be an illustrative example of one implementation of priority rules 151 in FIG. 1. Communication module 216 facilitates communication of local inventory queries generated by analysis module 214 to one or more other smart container devices and query responses from the other devices. Analysis module 214 receives the query responses via communication module 216 and generates a network inventory status 234 based on inventory status 226 and the received responses indicating individual inventory statuses of one or more other containers. Analysis module 214 uses the network inventory status 234 and set of rules 220 to determine whether to initiate a network inventory action.

A network inventory action may include, without limitation, generating a relocation instruction, generating a replenishment order, generating an inventory alert or notification, generating an order request for user verification, and/or any other suitable inventory management action. A relocation instruction may be an inventory relocation instruction generated based on priority rules 230, for example. An inventory notification may include information about the network inventory status for the inventory item, container locations for the inventory item, and/or a prompt for input related to the inventory status (i.e. user-initiated order, override order criteria, override network inventory status, etc.). An inventory alert may include information corresponding to the identified network inventory status, and may be tied into an existing ordering system to trigger an auto-generation of an order, for example.

In some examples, smart container device 202 includes inventory management component 236, which may be configured to manage network inventory based on a determination by analysis module 214 to initiate a network inventory action. Inventory management component 236 may include a client module 238, a cypher module 240, a registration module 242, a consensus module 244, a manager module 246, and a trigger module 248. The client module 238 is a component of the inventory management environment 200 that identifies one or more transaction requests. The client module 238 is configured to receive and/or identify one or more incoming messages. The incoming messages may be analyzed to determine whether the incoming messages include and/or are associated with a transaction request.

In some examples, the client module 238 is configured to identify and/or locate one or more other computing systems (e.g., smart container device 204, user device 250, etc.) and transmit one or more outgoing messages to the other computing systems. The outgoing messages may be transmitted, for example, to one or more computing systems in response to the transaction requests. In some examples, the client module 238 authenticates one or more computing systems and/or users (e.g., user 252).

The cypher module 240 is a component of the inventory management environment 200 that transforms data between a plurality of forms. The cypher module 240 may be used, for example, to protect the smart container device 202, environment 200, and/or data transmitted to and/or from the environment 200. The cypher module 240 is configured to convert readily-unintelligible data into readily-intelligible data. A message including encrypted information in cyphertext form, for example, may be decrypted to generate and/or identify information in plaintext form. In some examples, the cypher module 240 is configured to convert readily-intelligible data into readily-unintelligible data. A message including information in plaintext form, for example, may be encrypted to generate and/or identify encrypted information in cyphertext form.

The registration module 242 is a component of the inventory management environment 200 that processes one or more transaction requests. The registration module 242 is configured to analyze the transaction requests to determine whether to approve or not approve (e.g., reject) the transaction requests. In some examples, the registration module 242 generates transaction data associated with the transaction requests. Transaction data associated with one or more approved transaction requests may be registered, for example, to enable one or more computing systems to identify and/or locate a transaction associated with the transaction data. Transaction data may include, for example, a transaction identifier, a device identifier, a user identifier, a transaction date, a transaction time, a transaction location, and/or a transaction amount.

The consensus module 244 is a component of the inventory management environment 200 that validates one or more transactions associated with one or more transaction requests. The consensus module 244 is configured to determine whether the transaction data associated with the transaction requests is reliable, or at least likely to be reliable. In some examples, the consensus module 244 compares the transaction data with other data to determine whether the other data corroborates or supports the transaction data. The consensus module 244 may determine that the transaction data is reliable, for example, if the other data corroborates or supports the transaction data. One or more transactions associated with one or more transaction requests may be validated on condition that transaction data associated the transaction requests is determined to be reliable.

The manager module 246 is a component of the inventory management environment 200 that administers or manages one or more smart container devices (e.g. smart container device 202, smart container device 204). The manager module 246 is configured to analyze transaction data to identify one or more smart container devices and/or users 252, and administers or manages one or more accounts associated with the smart container devices and/or users 252 based on the transaction data. In some examples, the manager module 246 generates and/or modifies profile information associated with the smart container devices and/or users 252. The profile information may be representative of a state or configuration of the smart container device(s).

The trigger module 248 is a component of the inventory management environment 200 that monitors one or more smart container devices and/or users 252 associated with the accounts. The trigger module 248 is configured to perform one or more predetermined operations in accordance with profile information associated with the smart container devices and/or users 252. In some examples, the trigger module 248 uses profile information to automatically configure a smart container device (e.g. smart container device 202). Additionally, or alternatively, the trigger module 248 may use the profile information to generate and/or transmit one or more alerts or notifications associated with the smart container device 202 and/or users 252.

In some examples, the smart container device 202 communicates with a user device 250 (e.g., via the communication network 254) to provide cloud-based services to the users 252. For example, the users 252 may use the user device 250 to remotely operate the smart container device 202. In some examples, the user device 250 provides an instance of the smart container component 210 (e.g., a client-side application) for presenting information to and/or receiving user input from the users 252 while inventory management operations are performed on the backend at the smart container device 202. The user device 250 may include an operating system that enables the instance of the smart container component to be provided in a user-friendly manner. For example, the operating system may include one or more application program interfaces (APIs) that enable the user device 250 to present information to and/or receive user input from the user 252 using a user interface 256 and/or transmit data to and/or receive data from one or more other computing systems (e.g., smart container device 202, smart container device 204) using a network interface 258.

In some examples, user device 250 may be provisioned as a federated entity to be used in hosting and providing a private key of the associated user, such as user 252, to the distributed ledger used to maintain and control the transactions associated with smart container device 202. User device 250 may be used to provision and/or deprovision access of smart container devices (e.g. smart container device 202, smart container device 204) to the user's network of devices, in some examples. User device 250 may enable a user to configure customized levels of control and access per device (e.g. smart container device 202) using the instance of the smart container component implemented on user device 250. Customized levels of control and access may include: limited access, one-time access, full-authority access, specific channels of activity access, and any other suitable control customization. In other examples, user device 250 may be provisioned to provide private key information for authenticating and/or provisioning other devices, but may have restricted management access or otherwise limited authority. As used herein, a user may be a human user, an entity, such as a store or company, and/or a smart container device.

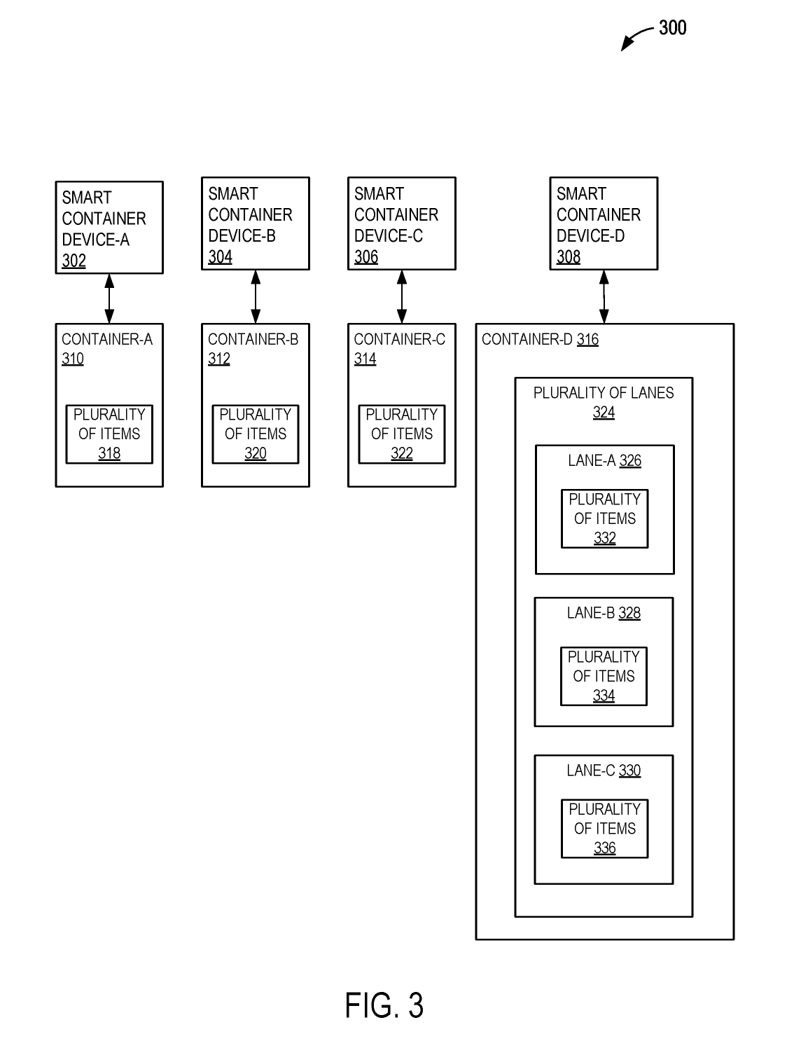

FIG. 3 is a block diagram illustrating an example inventory management environment 300 having a plurality of smart container devices and a plurality of associated containers. The smart container devices depicted herein for illustrative purposes may be examples of one implementation of smart container devices, such as computing devices 104, 106, 108, 110 in FIG. 1 and/or smart container devices 202, 204 in FIG. 2.

Environment 300 includes smart container device-A 302, smart container device-B 304, smart container device-C 306, smart container device-D 308, container-A 310, container-B 312, container-C 314, and container-D 316. In this example, smart container device-A 302 is associated with container-A 310, smart container device-B 304 is associated with container-B 312, smart container device-C 306 is associated with container-C 314, and smart container device-D 308 is associated with container-D 316.

In these examples, container-A 310 includes plurality of items 318, container-B 312 includes plurality of items 320, and container-C 314 includes plurality of items 322. A plurality of items may represent one or more items of a same item type or one or more items of one or more different item types. Container-D 316 may include plurality of lanes 324. Plurality of lanes 324 may be sub-sets of space within and/or apportioned from container-D 316. For example, a lane may be a range of space that represents a portion of container-D 316 relative to the available space of container-D 316. In some examples, lanes may be horizontally parallel along a single plane, such as along a shelf. In other examples, lanes may be vertically parallel, such as shelves of a cabinet or pantry. Each lane in plurality of lanes 324 may have a designated dimensionality or spatial range relative to container-D 316, and may have an individual item association, for example. Lane-A 326 may include plurality of items 332, lane-B 328 may include plurality of items 334, and lane-C 330 may include plurality of items 336.

Although FIG. 3 depicts four smart container devices and four containers for illustrative purposes, any number of smart container devices and/or containers may be implemented in environment 300 without departing from the spirit or scope of the disclosure herein. Additionally, although individual containers are depicted as having an individually associated smart container device, a container may have one or more associated devices, and a smart container device may have one or more associated containers.

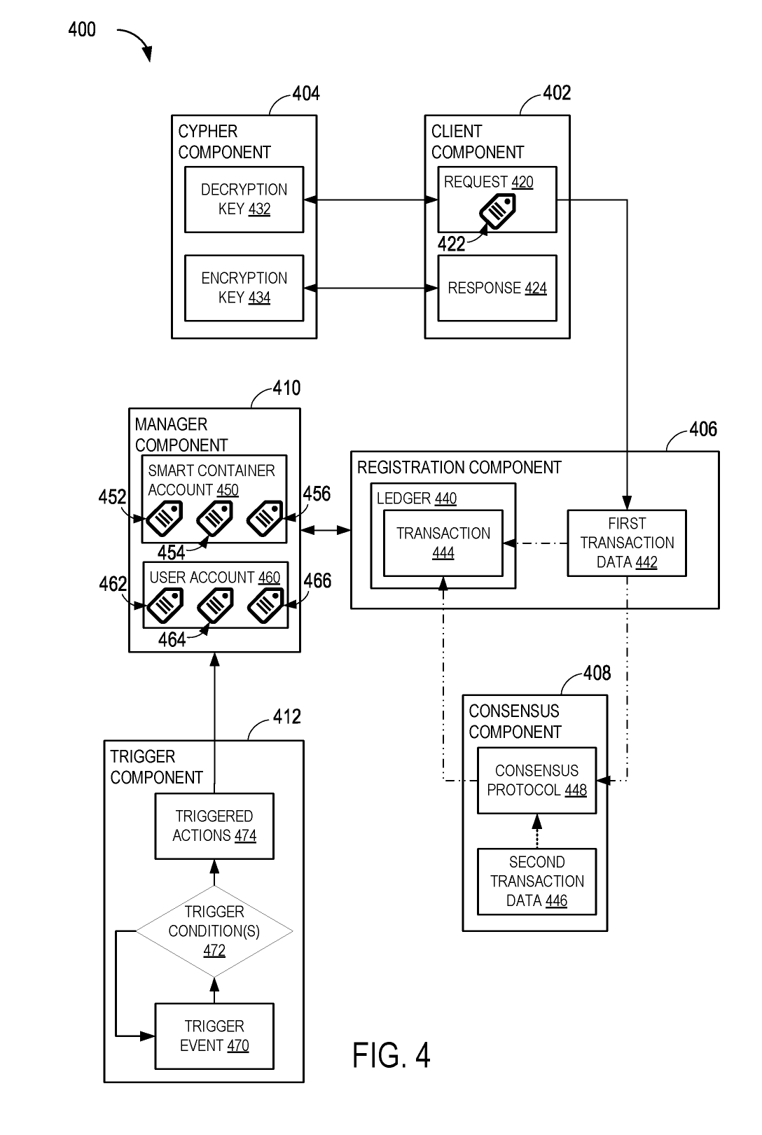

FIG. 4 is a block diagram illustrating an example inventory management environment 400 for managing a smart container device, such as computing device 104 in FIG. 1 and/or smart container device 202 in FIG. 2. The inventory management environment 400 is an example of one implementation of the inventory management environment 200 in FIG. 2. The inventory management environment 400 includes a client component 402, a cypher component 404, a registration component 406, a consensus component 408, a manager component 410, and a trigger component 412.

The client component 402 is configured to identify a transaction request 420. The transaction request 420 may be associated with, for example, an establishment of a communication link, an implementation of a configuration, an installation of firmware, and/or an inventory order request. The client component 402 may communicate with one or more other computing systems (e.g., smart container device 202, user device 250) to receive one or more messages. In some examples, the client component 402 processes or analyzes a message to determine whether the message is, includes, or is associated with a transaction request 420. For example, a message including one or more identifiers 422 may be interpreted and/or identified as a transaction request 420. Example identifiers 422 may include a transaction identifier, a smart container device identifier, user credentials, and the like.

In some examples, the client component 402 communicates with the smart container device 202 and/or user device 250 to transmit one or more messages. For example, the client component 402 may transmit a response 424 to a transaction request 420 received from the smart container device 202 and/or user device 250. The client component 402 may analyze the transaction request 420 to generate the response 424. Additionally, or alternatively, the client component 402 may analyze the transaction request 420 to identify and/or locate the smart container device 202 and/or user device 250. In some examples, the user device 250 may be identified and/or located using one or more identifiers 422 included in or associated with the transaction request 420.

The cypher component 404 is configured to transform data between a readily-unintelligible form and readily-intelligible form. The cypher component 404 may communicate with the client component 402 to obtain one or more encrypted messages received from the smart container device 202 and/or user device 250, such as an encrypted transaction request 420. In some examples, the cypher component 404 processes or analyzes an encrypted message using a decryption key 432 to generate intelligible information (e.g., in plaintext form) corresponding to the encrypted message.

In some examples, the cypher component 404 communicates with the client component 402 to provide one or more encrypted messages for transmission to the smart container device 202 and/or user device 250. For example, the cypher component 404 may process a response 424 using an encryption key 434 to generate unintelligible data (e.g., in cyphertext form) corresponding to the response 424 (e.g., an encrypted response 424), and communicate with the client component 402 for transmitting the encoded response 424 to the smart container device 202 and/or user device 250.

The registration component 406 is configured to maintain or manage a record or ledger 440. The ledger 440 enables a state or configuration of the smart container device, or smart container device network, to be monitored and managed. The registration component 406 may communicate with the client component 402 and/or cypher component 404 to obtain one or more transaction requests 420. In some examples, the registration component 406 processes or analyzes the transaction request 420 to identify and/or generate first transaction data 442 associated with the transaction request 420. The first transaction data 442 may be used to determine whether to approve or not approve the transaction request 420 and/or whether to record or register the first transaction data 442 in the ledger 440.

In some examples, the registration component 406 determines whether the smart container device associated with the transaction request 420 is legitimate, whether the user associated with the transaction request 420 is legitimate or authorized to enter into a transaction, and/or whether the user agrees to enter into the transaction. If the smart container device is not legitimate (e.g., counterfeit), the user is not authorized (e.g., unauthorized), and/or the user does not agree, the registration component 406 does not approve the transaction request 420 and/or does not register the first transaction data 442 in the ledger 440. On the other hand, if the smart container device is legitimate, the user is authorized, and the user agrees, the registration component 406 approves the transaction request 420 and/or registers the first transaction data 442 in the ledger 440.

The consensus component 408 is configured to validate a transaction 444 associated with the transaction request 420. The consensus component 408 may communicate with the registration component 406 to obtain first transaction data 442 associated with the transaction request 420. Additionally, the consensus component 408 may communicate with one or more other computing systems to determine whether the first transaction data 442 is reliable. In some examples, the consensus component 408 transmits the first transaction data 442 (e.g., a local instance of the transaction request 420) to the other computing systems and/or receive second transaction data 446 associated with the transaction request 420 (e.g., one or more remote instances of the transaction request 420) from the other computing systems.

If the first transaction data 442 is the same as or consistent with the second transaction data 446 (e.g., if the second transaction data 446 corroborates or supports the first transaction data 442), the consensus component 408 validates the transaction 444 using the first transaction data 442 and/or the second transaction data 446. On the other hand, if the first transaction data 442 is inconsistent (e.g., conflicts) with the second transaction data 446, the consensus component 408 settles or reconciles one or more inconsistencies between the first transaction data 442 and the second transaction data 446, and validates the transaction 444 using the reconciled transaction data (e.g., first transaction data 442, second transaction data 446, or other transaction data). The inconsistencies may be settled, for example, using a consensus protocol 448.

The manager component 410 is configured to administer or manage one or more smart container devices in a network of smart container devices. The manager component 410 may communicate with the registration component 406 to identify one or more smart containers associated with the transaction 444, and administer or manage one or more smart container accounts 450 associated with the smart containers. A smart container account 450 may include or be associated with profile information, such as a smart container device identifier 452, a smart container device type 454, and configuration data 456. The smart container device identifier 452 includes any data that enables the smart container device to be identified and/or authenticated. Example smart container device identifiers 452 include names, identification numbers, serial numbers, media access controller (MAC) addresses, Uniform Resource Identifiers (URIs), public key infrastructure (PM) certificates, security tokens, BLUETOOTH® brand wireless technology identifiers, ZIGBEE® brand wireless technology identifiers, Z-WAVE™ brand wireless technology identifiers, IP addresses, NFC identifiers, RFID identifiers, phone numbers, and the like. Example smart container device types 454 may include, without limitation, smart refrigerators, smart freezers, smart shelfs, smart displays, smart modular, smart containers, portable smart container devices, and the like.

Additionally, the manager component 410 may identify one or more users 252 associated with the transaction 444, and administer or manage one or more user accounts 460 associated with the users 252. A user account 460 may include account data, such as user credentials 462, contact data 464, and container device data 466. The user credentials 462 include any data that enables the user 252 to be identified and/or authenticated. For example, the user credentials 462 may be used to selectively allow the user 252 to access and use the account data. Example user credentials 462 include usernames, identification numbers, passwords, personal identification numbers (PINs), signatures, voiceprints, body postures or gestures, biometric data, PKI certificates, security tokens, phone numbers, email addresses, mailing addresses, and the like. Contact data 464 includes any data that enables the user 252 to be located and/or approached for establishing a communication link for communicating with the user 252, such as a phone number, an email address, a mailing address, and the like. Container device data 466 demonstrates and/or substantiates that the user 252 is associated with one or more smart container devices. For example, the container device data 466 may allow the user 252 to access and/or use the smart container device(s) and/or data associated with the smart container device(s) (e.g., profile information). In some examples, the container device data 466 includes or is associated with the profile information associated with the smart container devices.

The trigger component 412 is configured to monitor the smart container devices and/or users associated with the smart container device accounts 450 and/or user accounts 460, respectively. The trigger component 412 may communicate with the manager component 410 to identify profile information associated with the smart container device accounts 450 and/or user accounts 460 for performing one or more predetermined operations. In some examples, the trigger component 412 communicates with the registration component 406 to identify one or more transactions 444 associated with a triggering event 470. Example triggering events 470 include a communication link being established, a configuration becoming available, firmware becoming available, initiation of a network inventory action, and the like.

Upon detecting and/or identifying an occurrence of a triggering event 470, the trigger component 412 evaluates one or more predetermined trigger conditions 472 to determine whether to perform one or more triggered actions 474. Example trigger conditions 472 include a smart container device configuration, a smart container device state, a configuration state, a smart container device location and/or relocation, a network inventory action, and the like. If the trigger conditions 472 are not satisfied, the trigger component 412 continues to monitor the smart container devices. On the other hand, if the trigger conditions 472 are satisfied, the trigger component 412 performs the triggered actions 474. The triggered actions 474 may be performed, for example, to configure a smart container device, determine a reference configuration for a newly provisioned smart container device, modify the reference configuration, install firmware, modify profile information, generate a notification associated with the smart container device and/or smart container network, and/or perform a network inventory action.

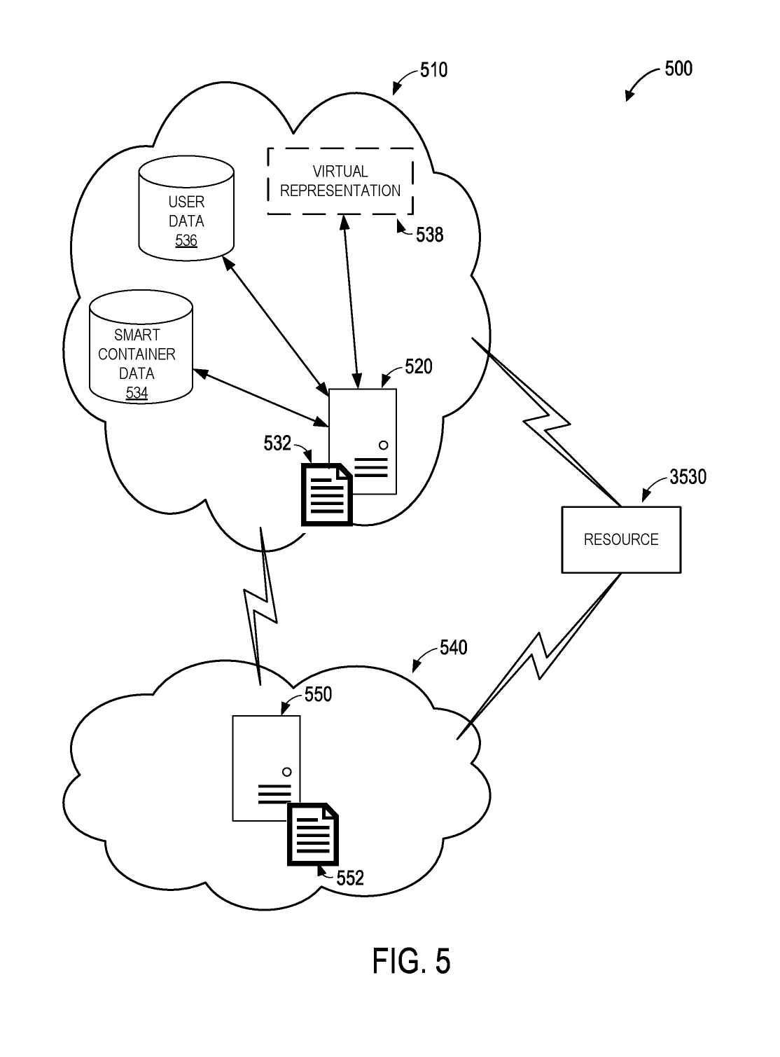

FIG. 5 is a block diagram illustrating an example inventory management environment 500 operating as a cloud-based service using blockchain technology. The inventory management environment 500 may be an illustrative example of the inventory management environment 100 in FIG. 1, the inventory management environment 200 in FIG. 2, the inventory management environment 300 in FIG. 3, and/or the inventory management environment 400 in FIG. 4. The inventory management environment 500 may be implemented in a cloud-based environment, such as an IoT server network 510, with one or more operations performed in the cloud. For example, one or more appliance management operations, such as those depicted in FIGS. 4, 7, 8, 9, and 10, may be performed at the IoT server network 510.

The IoT server network 510 may be communicatively coupled to one or more computing systems or resources in an IoT ecosystem via a communication network (e.g., communication network 124). The IoT server network 510 includes one or more primary or first server systems 520 (e.g., computing device 104) that use one or more server-side applications to provide one or more client-side services at one or more other resources in the IoT ecosystem. Additionally, or alternatively, a resource may use one or more client-side applications to present and/or obtain information while appliance management operations are performed on the backend at a first server system 520.

A resource 530 (e.g., computing device 104, smart container device 202, user device 250), for example, may transmit a transaction request 420 to the first server system 520 to initiate a session through which one or more transactions (e.g., transaction 444) may transpire. The transaction request 420 may be processed to generate first transaction data 532 (e.g., first transaction data 442). In some examples, the first server system 520 analyzes the first transaction data 532 to identify the resource 530 and/or a user associated with the resource 530 (e.g., user 252) for administering or managing one or more accounts associated with the transaction request 420 (e.g., smart container device account 450, user account 460). Smart container device data 534 associated with the resource 530 (e.g., smart container device account 450) and/or user data 536 associated with the user 252 (e.g., user account 460), for example, may be generated and/or modified based on the first transaction data 532.

The first server system 520 may store and/or maintain one or more virtual representations 538 of the resource 530. The virtual representation 538 may be representative, for example, of a state or configuration of the resource 530. In some examples, the first server system 520 generates a virtual representation 538 using smart container device data 534 and/or user data 536. Additionally, or alternatively, the first server system 520 may receive a virtual representation 538 from one or more computing systems. The virtual representation 538 may be, include, or be associated with a Representational State Transfer (REST) API that enables the resource 530 to provide a current state or configuration of the resource 530 to and/or obtain a desired state or configuration of the resource 530 (e.g., a reference configuration) from the first server system 520.

A blockchain server network 540 may support one or more inventory management operations performed in the IoT ecosystem. The blockchain server network 540 includes one or more secondary or second server systems 550 that use one or more server-side applications to provide one or more client-side services at one or more other resources in the IoT ecosystem. Additionally, or alternatively, a resource may use one or more client-side applications to present and/or obtain information while blockchain operations are performed on the backend at a second server system 550.

The first server system 520 may transmit first transaction data 532 to the second server system 550 to validate a transaction 444 associated with the first transaction data 532. For example, the first transaction data 532 may be compared with second transaction data 552 stored and/or maintained at the second server system 550 (e.g., second transaction data 446). In some examples, the first server system 520 validates the transaction 444 on condition that the second transaction data 552 corroborates or supports the first transaction data 532.

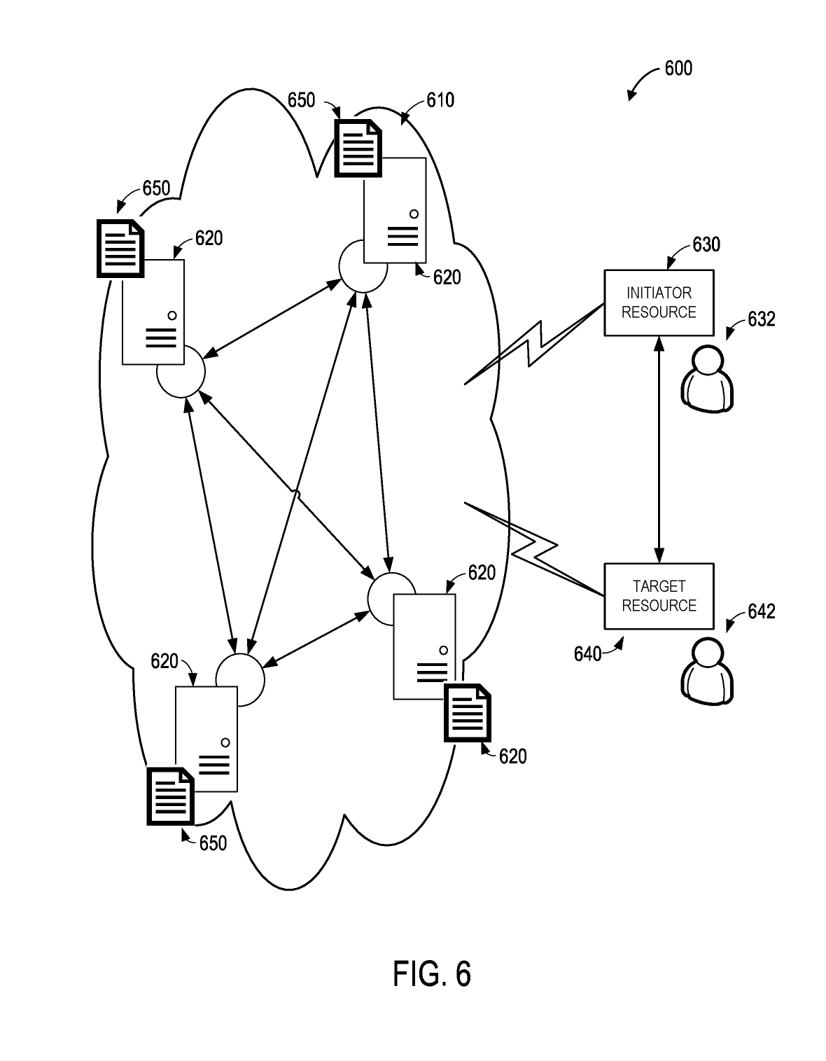

FIG. 6 is a block diagram illustrating an example inventory management environment 600 operating as a cloud-based service using a distributed network 610. The inventory management environment 600 may be an illustrative example of the inventory management environment 100 in FIG. 1, the inventory management environment 200 in FIG. 2, the inventory management environment 300 in FIG. 3, and/or the inventory management environment 400 in FIG. 4. The inventory management environment 600 may be implemented in a cloud-based environment, such as a distributed network 610, with one or more operations performed in the cloud. For example, one or more appliance management operations, such as those depicted in FIGS. 2, 7, 8, 9, and 10, may be performed at the distributed network 610.

The distributed network 610 may be communicatively coupled to one or more computing systems or resources (e.g., computing device 104, smart container device 202, user device 252) in an IoT ecosystem via a communication network (e.g., communication network 124). The distributed network 610 includes a plurality of nodes 620 (e.g., second server system 550) that use one or more server-side applications to provide one or more client-side services at the resources. Additionally, or alternatively, a resource may use one or more client-side applications to present and/or obtain information while appliance management operations are performed on the backend at a node 620.

A resource in the IoT ecosystem may be associated with one or more roles and, thus, is associated with a single role in the context of a single corresponding transaction. An initiator resource 630 associated with a first user 632 may be used to transmit a request message to a target resource 640 associated with a second user 642. The request message may be transmitted, for example, to initiate or start a session between the initiator resource 630 and the target resource 640. In some examples, the request message is associated with controlling or monitoring the initiator resource 630 or target resource 640 and/or with transmitting sensor data or profile information between the initiator resource 630 and target resource 640. The target resource 640 processes the request message and, in some examples, transmits a response message to the initiator resource 630. The request message may be analyzed, for example, to determine whether to approve or not approve the request message.

In some examples, the initiator resource 630 and/or target resource 640 generates a transaction request 420 associated with a transfer between the first user 632 and second user 642, and broadcasts the transaction request 420 to the distributed network 610. In this manner, one or more nodes 620 in the distributed network 610 may obtain the transaction request 420. The transaction request 420 may be generated, for example, using a private key, a public key, and/or a representation of a key (e.g., an encrypted key, a hash, an encrypted hash).

Upon obtaining the transaction request 420, a node 620 processes the transaction request 420 to generate transaction data 650 (e.g., first transaction data 442, second transaction data 446) and broadcasts the transaction data 650 to the distributed network 610. Each node 620 that obtains a transaction request 420 may independently process the transaction request 420 to generate an instance of the transaction data 650. In this manner, a node 620 may transmit an instance of the transaction data 650 that is local to that node 620 (e.g., a local instance) to one or more other nodes 620 and/or receive one or more instances of the transaction data 650 that are local to one or more other nodes 620 (e.g., one or more remote instances) from those other nodes 620. A node 620 may be configured to broadcast transaction data 650 that is new to that node 620. For example, the node 620 may broadcast transaction data 650 generated at that node 620 and/or rebroadcast transaction data 650 received from one or more other nodes 620.

The nodes 620 in the distributed network 610 record or register transaction data 650 in a record or ledger (e.g., ledger 440). Each node 620 that generates and/or receives transaction data 650 may independently register the transaction data 650 in a ledger 440 that is local to that node 620. In some examples, the node 620 uses a transaction identifier associated with the transaction data 650 to determine whether to register the transaction data 650. The transaction identifier may include, for example, a public key, a representation of the public key (e.g., an encrypted key, a hash, an encrypted hash), and/or a link to the public key.

If the ledger 440 does not include an instance of the transaction data 650 (e.g., the ledger 440 does not include transaction data associated with a transaction identifier that corresponds to or matches the transaction identifier associated with the transaction data 650), the node 620 registers the transaction data 650 in the ledger 440. On the other hand, if the ledger 440 includes an instance of the transaction data 650, the node 620 implements a consensus protocol 448 to determine whether to accept, reject, or modify the transaction data in the ledger 440 and/or the transaction data 650. If there is consensus among the nodes 620 in the distributed network 610, a transaction 444 associated with the transaction data 650 may be validated.

To facilitate controlling or managing the transaction data 650 in a transparent and verifiable manner, the transaction 444 may be recorded in the ledger 440 using blockchain technology. Data associated with the transaction 444, for example, may be stored on a blockchain. The ledger 440 may be used to demonstrate and/or substantiate that the transaction 444 is legitimate, that the parties to the transaction 444 (e.g., first user 632, second user 642) have the capacity or authority to enter into the transaction 444, and/or that the parties agree to enter into the transaction 444.

A plurality of transactions may be chained together in chronological order to form a block. For example, an input to a transaction may be associated with an output from a previous transaction, and/or an output from a transaction may be associated with an input to a subsequent transaction. In some examples, an output from a transaction may be spent or used once. For example, upon using an output from a transaction as an input to another transaction, the output may be identified or recognized as being spent. Using a spent output as an input to a transaction may render the transaction invalid (e.g., the transaction may be rejected). In some examples, an output may be partitioned for use as an input to a plurality of transactions, and/or a plurality of outputs may be combined for use as an input to a single transaction.

A plurality of blocks may be chained together in chronological order to form a blockchain. A block includes a block header and a hash of a previous block's block header. Additionally, the block header may be hashed and stored in a subsequent block. The block header may include an identifier associated with one or more transactions in the block. In some examples, the transactions in a block are iteratively hashed and paired to generate the identifier (e.g., a merkle root of a merkle tree).

The blocks may be traversed in reverse chronological order to validate one or more transactions in the blockchain. A proof of work, for example, may be used to demonstrate and/or substantiate that one or more operations were performed to validate a transaction and/or generate a block. In some examples, a node 620 in a distributed network 610 may analyze transaction data 650 associated with the transaction 444 to check that a local version of the blockchain is in sync with other versions in the distributed network 610. If the distributed network 610 includes a plurality of versions of the blockchain, a consensus protocol 448 may be implemented to identify a valid version. The valid version may be identified based on a block height or length.

The initiator resource 630, target resource 640, and/or one or more nodes 620 may be used to administer or manage a transaction 444 associated with the transaction request 420. Profile information, for example, may be used to demonstrate and/or substantiate that the first user 632 and/or second user 642 are authorized to access or use the sensor data or profile information and/or to remotely control or monitor the initiator resource 630 or target resource 640. In some examples, the initiator resource 630 and/or target resource 640 are configured to automatically authorize the first user 632 and/or second user 642 to access or use sensor data or profile information and/or to remotely control or monitor the initiator resource 630 or target resource 640. Additionally, or alternatively, one or more nodes 620 are configured to automatically authorize the first user 632 and/or second user 642 to access or use sensor data or profile information and/or to remotely control or monitor the initiator resource 630 or target resource 640. For example, the first user 632 and/or second user 642 may be authorized using the ledger 440.

FIG. 7 is a flowchart illustrating an example method for smart container inventory management. The method described herein may be implemented using an inventory management environment, such as inventory management environment 100 in FIG. 1, the inventory management environment 200 in FIG. 2, the inventory management environment 300 in FIG. 3, and/or the inventory management environment 400 in FIG. 4.

The process begins at operation 702 by obtaining sensor data. Sensor data may be obtained from a set of sensors, or sensor array, such as sensor array 126 in FIG. 1 and/or set of sensors 222 in FIG. 2. An analysis module of a smart container component may obtain the sensor data from a set of sensors associated with a smart container and configured to monitor the smart container. The sensor data obtained may be specific to the container or containers associated with or assigned to the smart container device communicatively coupled to the sensors, for example.

At operation 704, an inventory status is identified for the associated smart container by the analysis module based on the obtained sensor data. The inventory status may indicate the inventory level for one or more identified inventory items corresponding to the associated container, for example. At operation 706 a determination is made as to whether to initiate a local inventory query for the smart container based on the identified inventory status and a set of rules associated with the smart container.

If a determination is made at operation 706 not to initiate the local inventory query, the process returns to monitoring for sensor data and/or obtaining updated sensor data at operation 702. If a determination is made at operation 706 to initiate the local inventory query, the process generates an inventory status query at operation 708. The inventory status query may be generated by an analysis module of a smart container component based on one or more of a plurality of container data and a set of rules. The plurality of container data and/or the set of rules may be obtained by querying a network database in some examples, and used to determine one or more other smart container devices corresponding to one or more other containers associated with the identified inventory item(s), in order to generate a targeted query in some examples. In other examples, the query may be generated with inventory item identifier data and sent to all nodes within a network to obtain responses from the one or more other nodes associated with the identified inventory item(s).

At operation 710, the process sends the generated inventory status query via the local network to at least one other identified smart container or smart container device. At operation 712 the process receives at least one other inventory status corresponding to the identified inventory item(s) associated with the at least one other smart container via the local network of smart containers. The process calculates a network inventory value for the identified inventory item(s) at operation 714.

At operation 716, the process determines whether to initiate a network inventory action for the identified inventory item(s) based on the calculated network inventory value and a set of priority rules. The network database may include a plurality of container data and a set of priority rules, and the set of priority rules may include a container prioritization scheme, a container communication scheme, and any other suitable inventory management schemes. The process determines whether to initiate a network inventory action, including determining a type of inventory action to initiate based on the set of priority rules. Network inventory action types may include, without limitation, generating a relocation instruction, generating a replenishment order, generating an inventory alert or notification, or generating an order request for user verification, and the like.

If a determination is made not to initiate a network inventory action at operation 716, the process returns to monitoring for sensor data and/or obtaining updated sensor data at operation 702. If a determination is made to initiate a network inventory action, the process initiates the network inventory action at operation 718, with the process terminating thereafter, and/or iteratively repeating to continually monitor for container sensor data.

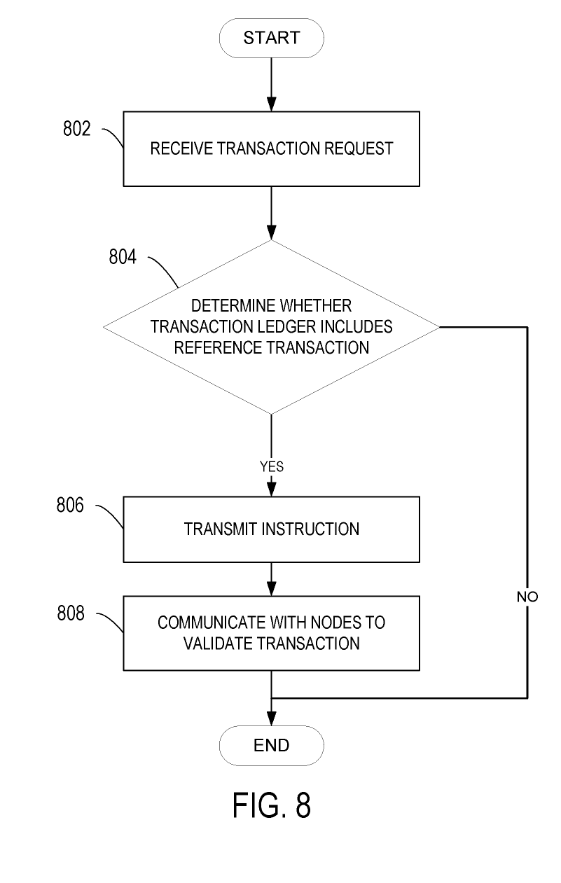

FIG. 8 is a flowchart illustrating an example method for managing one or more smart container devices in a smart container inventory management environment. The method may be implemented at a computing device, such as computing device 104 in FIG. 1 and/or smart container device 202 in FIG. 2. For example, the method may be implemented using the inventory management environment 100 in FIG. 1, the inventory management environment 200 in FIG. 2, the inventory management environment 300 in FIG. 3, and/or the inventory management environment 400 in FIG. 4.

A transaction request (e.g., transaction request 420) associated with a transfer between a user and a profile manager is received at operation 802. The transaction request 420 may be received from any resource 530 that enables the smart container device to function as described herein. For example, the transaction request 420 may be received from a computing device or from a first server system 520 associated with the profile manager. The resource 530 is associated with a smart container device type (e.g., smart container device type 454).

In some examples, the computing device determines at operation 804 whether a transaction ledger (e.g., ledger 440) includes transaction data associated with a reference transaction. The reference transaction may be associated with a reference configuration of a smart container device associated with the smart container device type 454, for example. The smart container device may determine whether the ledger 440 includes the transaction data, for example, on condition that the transfer is associated with an initial setup of the resource 530, such as a newly provisioned smart container device. Additionally, or alternatively, the computing device may determine whether the ledger 440 includes the transaction data on any other condition that enables the IoT ecosystem to function as described herein.

If a determination is made at operation 804 that the ledger 440 includes the transaction data, a configuration instruction is transmitted at operation 806 to the resource 530. In this example, the configuration instruction enables the resource 530 to be automatically configured to operate in accordance with the reference configuration. In some examples, the resource 530 analyzes the configuration instruction, and automatically configures the resource 530 in accordance with the reference configuration. Alternatively, the resource 530 may transmit, to the resource 530 or another resource associated with a user of the resource 530 (e.g., user device 250), a prompt instruction to present a prompt presentation for prompting the user to accept the reference configuration, and automatically configures the resource 530 in accordance with the reference configuration upon receiving user input associated with an acceptance of the reference configuration.

A transaction (e.g., transaction 444) associated with the transfer is validated at operation 808. In some examples, the computing device communicates with one or more computing systems (e.g., nodes) to validate the transaction 444. For example, the computing device may transmit first transaction data 442 to one or more nodes and/or receive or retrieve second transaction data 446 from one or more nodes to enable the first transaction data 442 to be compared with the second transaction data 446 for validating the transaction 444. Broadcasting the transaction data to a distributed network 610 including the nodes 620 enables a public ledger, including an ordered and timestamped record of the transaction 444, to be generated.

Although a configuration instruction is described herein for illustrative purposes, such as that of provisioning a newly added smart container device on the network, it should be understood the inventory management actions, such as order fulfillment actions, may also be performed using blockchain technology, enabling smart container devices as nodes of the distributed network to manage and execute inventory management decisions autonomously or semi-autonomously within the inventory management environment described herein.

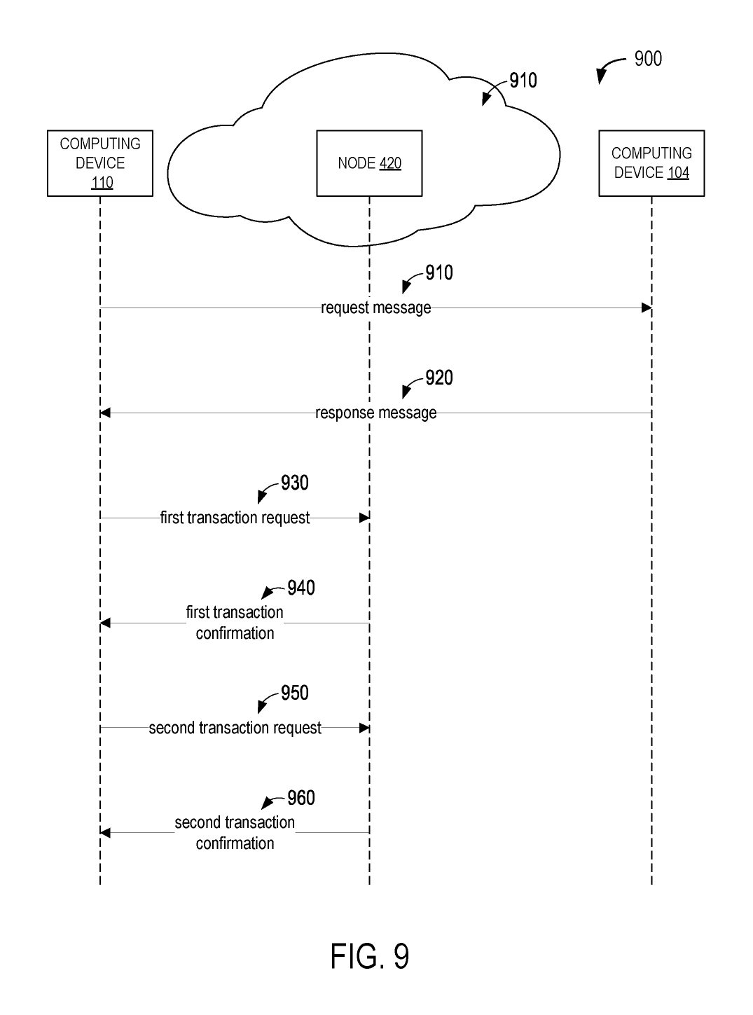

FIG. 9 is a sequence diagram illustrating an example method 900 for managing one or more computing devices 104 using a distributed network 910. The method 900 may be implemented using the inventory management environment 100 in FIG. 1, the inventory management environment 200 in FIG. 2, the inventory management environment 300 in FIG. 3, and/or the inventory management environment 400 in FIG. 4. The method 900 may be used, for example, to automatically set up computing device 104 upon connecting with the distributed network 910, for example.

A computing device 110 associated with a user (e.g., user 252) may transmit at operation 910 a request message to a computing device 104 associated with a profile manager. In some examples, the request message initiates or starts a session between the computing device 110 and the computing device 104. The request message may be transmitted, for example, to setup the computing device 110. Additionally, or alternatively, the request message may be transmitted to perform any operation that enables the IoT ecosystem to function as described herein.

The computing device 104 processes or analyzes the request message to determine whether to approve or not approve the request message. In some examples, the computing device 104 transmits at operation 920 a response message to the computing device 110. The response message may include, for example, a public key associated with the computing device 104, a representation of the public key (e.g., an encrypted key, a hash, an encrypted hash), and/or link to the public key.

The session includes one or more transactions associated with one or more inventory management actions. The computing device 110 may transmit a first transaction request (e.g., transaction request 420) to one or more nodes 620 in a distributed network 610 at operation 930, and receive a first transaction confirmation from the nodes 620 at operation 940. In some examples, the computing device 110 communicates with the computing device 104 and/or one or more nodes 620 to configure the computing device 110 based on a virtual representation of the computing device 110 (e.g., virtual representation 538). The virtual representation 538 may be associated, for example, with a desired state or configuration (e.g., reference configuration). The virtual representation 538 may be generated or modified at the computing device 104. Additionally, or alternatively, the virtual representation 538 or a modification to the virtual representation 538 may be received or retrieved from one or more computing systems, such as the computing device 110 and/or a user device 250 associated with the user 252. In some examples, the computing device 110 receives or retrieves the virtual representation 538 from the computing device 104 to synchronize a current state or configuration of the computing device 110 with the desired state or configuration. In this manner, the virtual representation 538 may be used to interact with the computing device 110.

If the computing device 104 does not include a virtual representation 538 (e.g., a ledger 440 stored and/or maintained at the computing device 104 does not include transaction data associated with a reference transaction), one or more other transaction ledgers are identified for generating and/or identifying the virtual representation 538. The other transaction ledgers may include, for example, other transaction data that may be used to generate a virtual representation 538. The other transaction data may be associated with one or more other computing devices (e.g. smart container devices) that are associated with smart container type of the computing device 110 (e.g., smart container device type 454). The computing device 104 may process or analyze the other transaction data, for example, to determine the reference configuration associated with the smart container device type 454.

In some examples, the computing device 110 transmits a second transaction request (e.g., transaction request 420) to the nodes 620 at operation 950, and receive a second transaction confirmation from the nodes 620 at operation 960. Alternatively, the second transaction request may be transmitted from and/or the second transaction conformation may be transmitted to the user device 250, a smart container device other than the computing device 110, and/or a computing system associated with smart container device manager (e.g., a master node). While the example session includes two transactions, the session may include any number of transactions that enable the IoT ecosystem to function as described herein.

In some examples, the smart container device 110, user device 250, other smart container device(s), and/or computing system associated with the smart container device manager transmits the second transaction request to set or establish a reference transaction. For example, the computing device 110 or user device 250 may communicate with the computing device 104 and/or one or more nodes 620 to recognize or identify a current state or configuration and/or a custom, user-desired state or configuration of the computing device 110 as a reference state or configuration. The reference configuration may be used, in some examples, to configure another smart container device associated with the smart container device type 454 of the computing device 110 to operate in accordance with the reference configuration. For another example, the other smart container device may communicate with the computing device 104 and/or one or more nodes 620 to recognize or identify a current state or configuration and/or a custom, another-user-desired state or configuration of the computing device 110 as a reference configuration associated with the smart container device type 454. For yet another example, the smart container device manager may communicate with the computing device 104 and/or one or more nodes 620 to generate and/or identify a reference configuration that enables the computing device 110 to install firmware.

In some examples, the computing device 110 collects, processes, analyzes, and/or acts on data generated at the computing device 110 and/or one or more other computing systems. Event condition action data, for example, may be used to generate one or more triggers for monitoring the computing device 110 and/or inventory status of a container associated with the computing device 110. The triggers may be responsive to data in the cloud, such as the transaction data. In some examples, the second transaction request is used to generate a trigger configured to present an alert or notification. For example, the trigger may be configured to transmit to one or more computing systems, such as the user device 250 and/or a computing system associated with a security manager, a notification associated with a connection state and/or location of the computing device 110. The trigger may be configured to identify the connection state and/or location of the computing device 110 on condition that the computing device 110 is coupled to one or more nodes 620 in the distributed network 610.

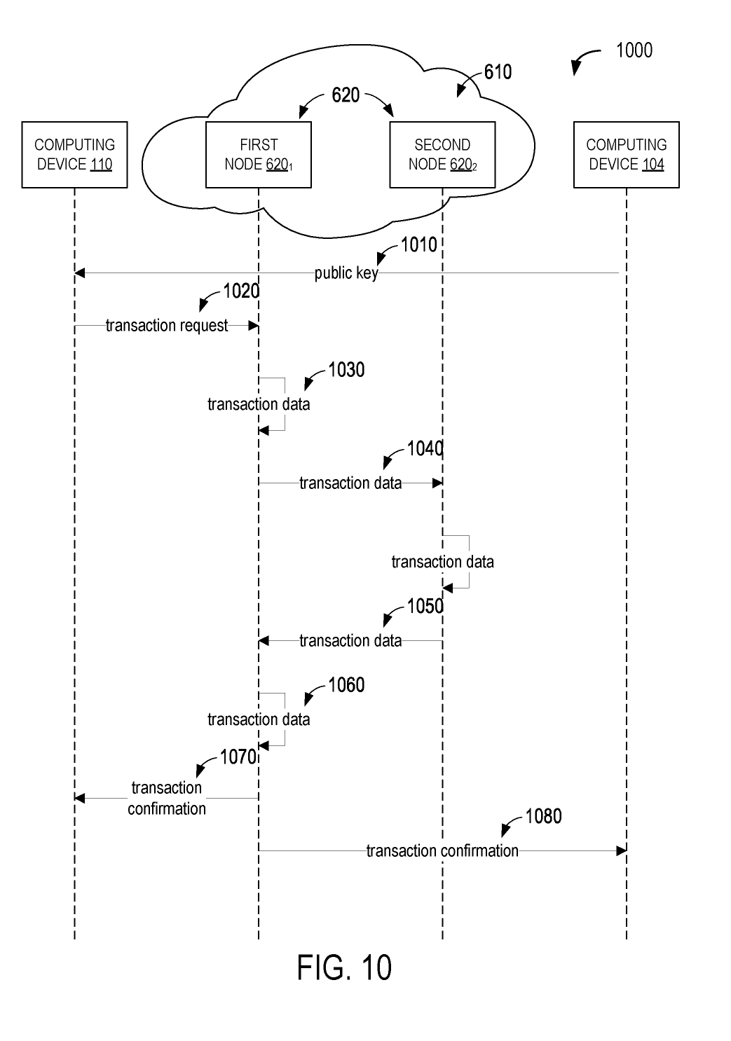

FIG. 10 is a sequence diagram illustrating an example method 1000 for managing one or more computing devices 110 using the distributed network 610. The method 1000 may be implemented using the inventory management environment described herein. The method 1000 may be used, for example, to record or register transaction data in a public ledger.

A computing device 110 associated with a user (e.g., user 252) may receive at operation 1010 an identifier from a computing device 104 associated with a profile manager. The identifier may include, for example, a public key associated with the profile manager, a representation of the public key (e.g., an encrypted key, a hash, an encrypted hash), and/or link to the public key. The computing device 110 uses the identifier to generate a transaction request 420 associated with a transfer between the user 252 and the profile manager.

The computing device 110 may transmit at operation 1020 the transaction request 420 to a first node 620₁ of a plurality of nodes 620, and the first node 620₁ may broadcast the transaction request 420 to a distributed network 610 including the nodes 620 to enable the nodes 620 to obtain the transaction request 420. Alternatively, the computing device 110 may broadcast the transaction request 420 to the distributed network 610. Upon receiving the transaction request 420, the first node 620₁ analyzes the transaction request 420 to generate transaction data 650, and registers at operation 1030 the transaction data 650 in a ledger (e.g., ledger 440). The first node 620₁ broadcasts the transaction data 650 to the distributed network 610 for validating the transaction data 650. For example, the transaction data 650 may be transmitted at operation 1040 to a second node 620₂ of the plurality of nodes 620. If the first node 620₁ receives at operation 1050 a remote instance of the transaction data 650 from the second node 620₂, the first node 620₁ analyzes the transaction data 650 to validate at operation 1060 the transaction data 650. In some examples, the first node 620₁ generates and transmits at operation 1070 a response to the transaction request to the computing device 110. The response may include a transaction confirmation. Additionally, or alternatively, the first node 620₁ may generate and/or transmit at operation 1080 a transaction confirmation to the computing device 104.

The examples described herein are configured to support plug-and-play configurations. For example, upon detecting a computing device 110 (e.g. smart container device) at an IoT ecosystem, the computing device 110 may be automatically configured to operate in accordance with a reference configuration. The reference configuration may be, for example, a default configuration of a computing device associated with the smart container device type 454. Alternatively, the reference configuration may be a user-provided configuration (e.g., via the computing device 110 and/or user device 250), an updated default configuration (e.g., using firmware received from smart container device manager), or another user-provided configuration (e.g., via another smart container device and/or user device associated with another user).

If a reference configuration is not available or accessible, a reference configuration may be generating using transaction data and/or profile information associated with one or more other users. For example, the reference configuration may be determined based on profile information associated with the user 252. In some examples, the computing device 110 may be a newer version of another smart container device associated with the user 252, and the computing device 110 may be automatically configured to adopt the configuration data associated with the other smart container device(s) upon establishing a communication link in the IoT ecosystem (e.g., with the computing device 104, with a node 610, etc.). Alternatively, the reference configuration may be determined based on configuration data associated with one or more other smart container devices associated with one or more other users on condition that the smart container devices are associated with the smart container device type 454.

In some examples, a user 252 may report a computing device 110 as lost or stolen. If the computing device 110 is reported as lost or stolen, an alert associated with the computing device 110 may be generated and transmitted upon detecting the computing device 110. For example, a connection status and/or location of the computing device 110 may be reported to the user 252 (e.g., via a user device 250) and/or to a security manager upon identifying that the computing device 110 is coupled to the IoT ecosystem and/or that a user other than the user 252 is accessing or using the computing device 110.

In other examples, the user device may be a wearable device that maintains the private key used to authorize the transaction. The computing device 110 may sync with the user device and be automatically provisioned as a smart container device on the user's network and added as a device in the distributed ledger management system. A user may configure customized levels of access and/or control for the smart container device, via the management environment (e.g. smart container component). The device may also be preloaded or preconfigured with device logic for customized levels of control and access, based on user preferences.

In addition, a user may view and modify levels of control and access of devices provisioned and/or deprovisioned in the system. For example, if the user obtains a new device, replacement device, or updated device (e.g. a new smart container device to replace an existing smart container device), an existing device may be removed, or deprovisioned, from the management system on the distributed ledger. This enables a user to dynamically control and modify the levels of access and control for each device on the system. As another example, a user may modify a level of access for dedicated or pre-defined time intervals, such as disabling a smart container device's ability to generate inventory orders during a defined time period, such as when the user is away on vacation, or when a store has an unexpected closure, for example.

The system and methods provided herein enable a user to access and view historical data pertaining to device actions, decisions, and the like, which are saved in the distributed ledger. All actions, negotiations, transactions, and interactions made by the device generate subsequent blocks stored in the chain of the distributed ledger. This enables a user to view previous interactions and transactions made by a device, such as a smart container device, at their discretion.

In some examples, the smart container or smart container device may detect when consumables are in need of replenishment, based on a schedule or other rule set, and automatically initiate order replenishment through the device's connection to a network using blockchain technology, as described herein. The smart container or smart container device may prepare a hash with the reordering elements, or send a request to the distributed ledger for the hash to be created with the reordering elements. When the smart container, or distributed ledger, distributes the hash to the fulfillment entities, the fulfillment entities may create a hash structure that meets the criteria, and whichever fulfillment entity returns a valid value first may “win” the order fulfillment. That value may then be added to the chain, and the transaction distributed to the winning entity, for example.

In other examples, aspects of the disclosure may provide a control smart container, or master smart container, that obtains sensor data from a number of containers associated with sensors or sensor sets absent an instance of the smart container component, or a smart container device. In other words, a number of standard containers having no network capability may be associated with sensors, or sensor sets may otherwise be disposed adjacent to the number of standard containers, to capture sensor data that is obtainable by a smart container. In this way, legacy containers may become part of a smart container network with a relatively minimal number of smart container devices implemented throughout the environment, for example. The master smart container may manage inventory status of the number of containers located remote from the master smart container using the obtained sensor data from the sensors associated with the containers.

Alternatively, or in addition to the other examples described herein, examples include any combination of the following:
a network database configured to store a plurality of container data and priority rules associated with a local network, wherein the plurality of container data includes individual container data for each individual monitored container in the local network, and wherein the individual container data comprises a container identifier, container parameters, and at least one associated inventory identifier;
on condition that a determination is made to initiate the local inventory query, generate an inventory status query corresponding to an inventory item associated with the monitored container;
send the generated inventory status query via a local network to at least one other smart container component implemented on another device associated with another monitored container;
receive at least one other inventory status corresponding to the inventory item associated with the other monitored container via the local network;
calculate a network inventory value for the inventory item;
determine whether to initiate a network inventory action for the inventory item based on the calculated network inventory value;
wherein the network inventory action is at least one of generating a relocation instruction, generating a replenishment order, generating an inventory alert or notification, or generating an order request for user verification;
wherein the smart container component generates the inventory status query using a plurality of container data obtained from a network database to identify target devices in the local network;
a network database configured to store a plurality of container data and priority rules associated with a local network, wherein the priority rules stored on the network database include a container prioritization scheme and a container communication scheme;
determine a type of inventory action to initiate based on the priority rules;
receive a transaction request, the transaction request associated with the determined network inventory action;
communicate with one or more nodes in a distributed network to validate the transaction request;
on condition that a determination is made to initiate the network inventory action for the inventory item, generate a transaction request corresponding to the inventory item;
send the generated transaction request to the inventory management component;
wherein the sensor array includes at least one of an optical sensor, an image capture device, a hyperspectral imaging sensor, a weight sensor, a thermometer, a barometer, a hygrometer, laser, lidar, an ultrasonic sensor, an infrared sensor, a photoionization detector, a gas sensor, an electrochemical gas sensor, or a scanner device;
a container module implemented on the memory and configured to store container data and a set of rules associated with the monitored container;
a network interface component configured to facilitate communication with a plurality of nodes in a network, wherein the smart container device is a node in the plurality of nodes;
obtaining, by a smart container component implemented on a processor, sensor data from a set of sensors associated with a smart container;
identifying an inventory status for the smart container using the obtained sensor data;
determining whether to initiate a local inventory query for the smart container based on the identified inventory status and a set of rules associated with the smart container;
on condition that a determination is made to initiate the local inventory query, generating an inventory status query corresponding to an inventory item associated with the smart container;
identifying at least one other smart container associated with the inventory item in a local network of smart containers, including by querying a network database;
sending the generated inventory status query via the local network to the identified at least one other smart container;
receiving at least one other inventory status corresponding to the inventory item associated with the at least one other smart container via the local network;
calculating a network inventory value for the inventory item;
determining whether to initiate a network inventory action for the inventory item based on the calculated network inventory value;
wherein the network inventory action is at least one of generating a relocation instruction, generating a replenishment order, generating an inventory alert or notification, or generating an order request for user verification;
wherein the network database includes a plurality of container data and a set of priority rules, the set of priority rules comprising a container prioritization scheme and a container communication scheme;
determining a type of inventory action to initiate based on the set of priority rules
a client component configured to receive a transaction request associated with a transfer between a user and a profile manager, and transmit a response to the transaction request;
a consensus component configured to generate a local instance of the transaction request, transmit the local instance of the transaction request to one or more nodes in a network, receive one or more remote instances of the transaction request from the one or more nodes in the network, and implement a consensus protocol to validate a transaction associated with the transfer;
a manager component configured to identify a reference transaction associated with a reference configuration of a smart container device associated with a smart container device type;
a manager component configured to obtain a custom configuration associated with the smart container device type, and determine whether to identify the custom configuration as the reference configuration associated with the smart container device type;
a manager component configured to identify one or more transaction ledgers that include transaction data associated with one or more other transactions, and analyze the transaction data to determine the reference configuration associated with the smart container device type; and
a trigger component configured to monitor the smart container device and/or a user or the smart container device, and automatically configure the smart container device to operate in accordance with the reference configuration;
on condition that the determined type of inventory action to initiate for the inventory item is a replenishment order, generating a transaction request corresponding to the inventory item;
sending the generated transaction request to an inventory management component;
on condition that the determined type of inventory action to initiate for the inventory item is a relocation instruction, generating the relocation instruction corresponding to the inventory item based on the calculated network inventory value and a container prioritization scheme;
sending the generated relocation instruction to a user interface device.

In some examples, the operations illustrated in FIGS. 4, 7, 8, 9, and 10 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure. Moreover, the inventory management environment described herein may be used in a broad range of environments including, without limitation, a home environment, a retail environment, a manufacturing environment, a supply chain environment, a healthcare environment, a transportation environment, an agricultural environment, and the like. While at least some examples of the disclosure are directed to an inventory management environment, aspects of the disclosure may be provided in a variety of environments in which aspects of the environment are monitored and managed.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Example Operating Environment

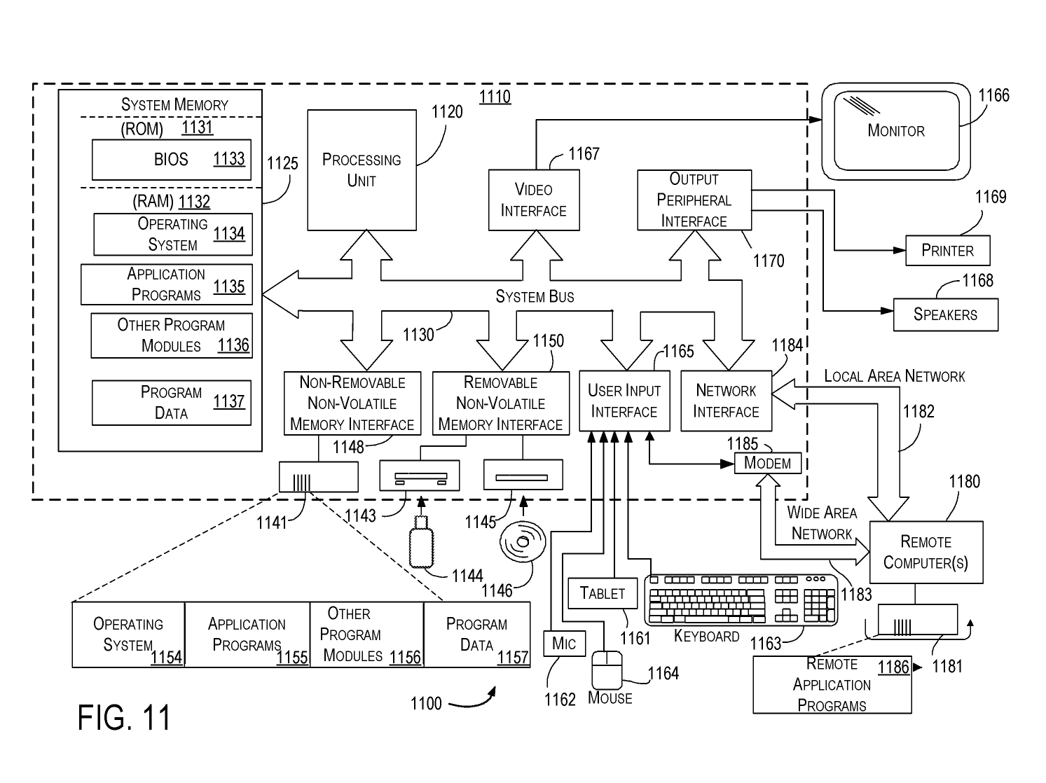

FIG. 11 is a block diagram illustrating an example operating environment 1100 for a computing device (e.g., computing device 104, 106, 108, 110, smart container device 202, etc.). The computing system environment 1100 is only one example of a suitable computing environment and is not intended to suggest any limitation as to the scope of use or functionality of the disclosure. Neither should the computing environment 1100 be interpreted as having any dependency or requirement relating to any one or combination of components illustrated in the example operating environment 1100.

The disclosure is operational with numerous other general purpose or special purpose computing system environments or configurations. Examples of well-known computing systems, environments, and/or configurations that may be suitable for use with the disclosure include, but are not limited to: personal computers, desktop computers, laptop computers, tablet devices, netbooks, handheld devices, mobile telephones, wearables, gaming devices, portable media players, server computers, kiosks, set top boxes, tabletop devices, multiprocessor systems, microprocessor-based systems, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 11, an example system for implementing various aspects of the disclosure may include a general-purpose computing device in the form of a computer 1110. Components of the computer 1110 may include, but are not limited to, a processing unit 1120, a system memory 1125, and a system bus 1130 that couples various system components including the system memory to the processing unit 1120. The system bus 1130 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1110 typically includes a variety of computer-readable media. Computer-readable media may be any available media that may be accessed by the computer 1110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Read only memory (ROM) 1131 and random-access memory (RAM) 1132 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may be accessed by the computer 1110. Computer storage media does not, however, include propagated signals. Rather, computer storage media excludes propagated signals. Any such computer storage media may be part of computer 1110.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 1125 includes computer storage media in the form of volatile and/or nonvolatile memory such as ROM 1131 and RAM 1132. A basic input/output system 1133 (BIOS), containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs, such as application programs 1135 (e.g., appliance management environment), other program modules 1136 and program data 1137.

The computer 1110 may also include other removable/non-removable, volatile/nonvolatile computer storage media. By way of example only, FIG. 11 illustrates a hard disk drive 1141 that reads from or writes to non-removable, nonvolatile magnetic media, a universal serial bus (USB) port 1143 that provides for reads from or writes to a removable, nonvolatile memory 1144, and an optical disk drive 1145 that reads from or writes to a removable, nonvolatile optical disk 1146 such as a CD ROM or other optical media. Other removable/non-removable, volatile/nonvolatile computer storage media that may be used in the example operating environment include, but are not limited to, magnetic tape cassettes, flash memory cards, digital versatile disks, digital video tape, solid state RAM, solid state ROM, and the like. The hard disk drive 1141 is typically connected to the system bus 1130 through a non-removable memory interface such as interface 1148, and USB port 1143 and optical disk drive 1145 are typically connected to the system bus 1130 by a removable memory interface, such as interface 1150.

The drives and their associated computer storage media, described above and illustrated in FIG. 11, provide storage of computer-readable instructions, data structures, program modules and other data for the computer 1110. In FIG. 11, for example, hard disk drive 1141 is illustrated as storing operating system 1154, application programs 1155 (e.g., an appliance management environment), other program modules 1156 and program data 1157. Note that these components may either be the same as or different from operating system 1134, application programs 1135, other program modules 1136, and program data 1137. Operating system 1154, application programs 1155, other program modules 1156, and program data 1157 are given different numbers herein to illustrate that, at a minimum, they are different copies.

A user may enter commands and information into the computer 1110 through input devices such as a tablet, or electronic digitizer, 1161, a microphone 1162, a keyboard 1163 and pointing device 1164, commonly referred to as mouse, trackball or touch pad. Other input devices not shown in FIG. 11 may include a joystick, game pad, digital camera, scanner, or the like. These and other input devices are often connected to the processing unit 1120 through a user input interface 1165 that is coupled to the system bus, but may be connected by other interface and bus structures, such as a parallel port, game port or a universal serial bus (USB). A monitor 1166 or other type of display device is also connected to the system bus 1130 via an interface, such as a video interface 1167. The monitor 1166 may also be integrated with a touchscreen panel or the like. Note that the monitor and/or touchscreen panel may be physically coupled to a housing in which the computing device 1110 is incorporated, such as in a tablet device. In addition, computers such as the computing device 1110 may also include other peripheral output devices such as speakers 1168 and printer 1169, which may be connected through an output peripheral interface 1170 or the like.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include one or more local area networks (LAN) 1182 and one or more wide area networks (WAN) 1183, but may also include other networks. Such networking environments are commonplace in offices, enterprise-wide computer networks, intranets and the Internet.

When used in a LAN networking environment, the computer 1110 is connected to the LAN 1182 through a network interface controller or adapter 1184. When used in a WAN networking environment, the computer 1110 typically includes a modem 1185 or other means for establishing communications over the WAN 1183, such as the Internet. The modem 1185, which may be internal or external, may be connected to the system bus 1130 via the user input interface 1160 or other appropriate mechanism. A wireless networking component such as comprising an interface and antenna may be coupled through a suitable device such as an access point or peer computer to a WAN or LAN. In a networked environment, program modules depicted relative to the computer 1110, or portions thereof, may be stored in the remote memory storage device. By way of example, and not limitation, FIG. 11 illustrates remote application programs 1185 as residing on memory device 1181. It may be appreciated that the network connections shown are exemplary and other means of establishing a communication link between the computers may be used.

The examples illustrated and described herein as well as examples not specifically described herein but within the scope of aspects of the disclosure constitute an example appliance management environment. For example, the elements illustrated in FIGS. 1-6 and 11, such as when encoded to perform the operations illustrated in FIGS. 4, 7, 8, 9, and 10, constitute an example means for obtaining, by a smart container component implemented on a processor, sensor data from a set of sensors associated with a smart container; an example means for identifying an inventory status for the smart container using the obtained sensor data; and/or an example means for determining whether to initiate a local inventory query for the smart container based on the identified inventory status and a set of rules associated with the smart container.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for smart container inventory management, the system comprising:
a memory storing computer-executable instructions;
a processor configured to execute the computer-executable instructions; and
a smart container component implemented on the memory and executed by the processor to:
obtain sensor data from a set of sensors configured to monitor a container;
identify an inventory status for the monitored container associated with the set of sensors based on the obtained sensor data; and
determine whether to initiate a local inventory query for the monitored container based on the identified inventory status.

2. The system of claim 1, further comprising:
a network database configured to store a plurality of container data and priority rules associated with a local network, wherein the plurality of container data includes individual container data for each individual monitored container in the local network, and wherein the individual container data comprises a container identifier, container parameters, and at least one associated inventory identifier.

3. The system of claim 1, wherein the smart container component is further executed by the processor to:
on condition that a determination is made to initiate the local inventory query, generate an inventory status query corresponding to an inventory item associated with the monitored container;
send the generated inventory status query via a local network to at least one other smart container component implemented on another device associated with another monitored container;
receive at least one other inventory status corresponding to the inventory item associated with the other monitored container via the local network;
calculate a network inventory value for the inventory item; and
determine whether to initiate a network inventory action for the inventory item based on the calculated network inventory value.

4. The system of claim 3, wherein the network inventory action is at least one of generating a relocation instruction, generating a replenishment order, generating an inventory alert or notification, or generating an order request for user verification.

5. The system of claim 3, wherein the smart container component generates the inventory status query using a plurality of container data obtained from a network database to identify target devices in the local network.

6. The system of claim 3, further comprising:
a network database configured to store a plurality of container data and priority rules associated with a local network, wherein the priority rules stored on the network database include a container prioritization scheme and a container communication scheme.

7. The system of claim 6, wherein determining whether to initiate the network inventory action further comprises the smart container component executed by the processor to:
determine a type of inventory action to initiate based on the priority rules.

8. The system of claim 3, further comprising:
an inventory management component implemented on the memory and executed by the processor to:
receive a transaction request, the transaction request associated with the determined network inventory action; and
communicate with one or more nodes in a distributed network to validate the transaction request.

9. The system of claim 8, wherein the smart container component is further executed by the processor to:
on condition that a determination is made to initiate the network inventory action for the inventory item, generate a transaction request corresponding to the inventory item; and
send the generated transaction request to the inventory management component.

10. A smart container device comprising:
a housing;
a processing unit implemented within the housing:
a memory communicatively coupled to the processing unit;
a sensor array implemented within the housing and configured to monitor a container associated with the smart container device; and
a smart container component implemented on the memory and executed by the processing unit to monitor sensor data generated by the sensor array to manage an inventory status for the monitored container.

11. The smart container device of claim 10, wherein the sensor array includes at least one of an optical sensor, an image capture device, a hyperspectral imaging sensor, a weight sensor, a thermometer, a barometer, a hygrometer, laser, lidar, an ultrasonic sensor, an infrared sensor, a photoionization detector, a gas sensor, or a scanner device.

12. The smart container device of claim 10, further comprising:
a container module implemented on the memory and configured to store container data and a set of rules associated with the monitored container.

13. The smart container device of claim 10, further comprising:
a network interface component configured to facilitate communication with a plurality of nodes in a network, wherein the smart container device is a node in the plurality of nodes.

14. A method of inventory management using smart containers, the method comprising:
obtaining, by a smart container component implemented on a processor, sensor data from a set of sensors associated with a smart container;
identifying an inventory status for the smart container using the obtained sensor data; and
determining whether to initiate a local inventory query for the smart container based on the identified inventory status and a set of rules associated with the smart container.

15. The method of claim 14, further comprising:
on condition that a determination is made to initiate the local inventory query, generating an inventory status query corresponding to an inventory item associated with the smart container;
identifying at least one other smart container associated with the inventory item in a local network of smart containers, including by querying a network database;
sending the generated inventory status query via the local network to the identified at least one other smart container;
receiving at least one other inventory status corresponding to the inventory item associated with the at least one other smart container via the local network;
calculating a network inventory value for the inventory item; and
determining whether to initiate a network inventory action for the inventory item based on the calculated network inventory value.

16. The method of claim 15, wherein the network inventory action is at least one of generating a relocation instruction, generating a replenishment order, generating an inventory alert or notification, or generating an order request for user verification.

17. The method of claim 15, wherein the network database includes a plurality of container data and a set of priority rules, the set of priority rules comprising a container prioritization scheme and a container communication scheme.

18. The method of claim 17, wherein determining whether to initiate the network inventory action further comprises:
determining a type of inventory action to initiate based on the set of priority rules.

19. The method of claim 15, further comprising:
on condition that the determined type of inventory action to initiate for the inventory item is a replenishment order, generating a transaction request corresponding to the inventory item; and
sending the generated transaction request to an inventory management component.

20. The method of claim 15, further comprising:
on condition that the determined type of inventory action to initiate for the inventory item is a relocation instruction, generating the relocation instruction corresponding to the inventory item based on the calculated network inventory value and a container prioritization scheme; and
sending the generated relocation instruction to a user interface device.
